(19) United States
(12) Patent Application Publication
(10) Pub. No.: US 2025/0373375 A1
(43) Pub. Date: Dec. 4, 2025

(54) METHOD AND DEVICE FOR DATA TRANSMISSION AND RECEPTION IN MOBILE COMMUNICATION SYSTEM IN MTRP ENVIRONMENT

(71) Applicants: HYUNDAI MOTOR COMPANY, Seoul (KR); KIA CORPORATION, Seoul (KR); SEOUL NATIONAL UNIVERSITY R&DB FOUNDATION, Seoul (KR)

(72) Inventors: Gene Back Hahn, Hwaseong-si, Gyeonggi-do (KR); Young Kil Suh, Hwaseong-si, Gyeonggi-do (KR); Ui Hyun Hong, Hwaseong-si, Gyeonggi-do (KR); Bum Jun Kim, Seoul (KR); Jeonghyeon Kwon, Seoul (KR); Wan Choi, Seoul (KR)

(73) Assignees: HYUNDAI MOTOR COMPANY, Seoul (KR); KIA CORPORATION, Seoul (KR); SEOUL NATIONAL UNIVERSITY R&DB FOUNDATION, Seoul (KR)

(21) Appl. No.: 18/872,630

(22) PCT Filed: Aug. 2, 2023
(86) PCT No.: PCT/KR2023/011356

§ 371 Date: Dec. 6, 2024

(30) Foreign Application Priority Data
Aug. 2, 2022 (KR) 10-2022-0096220

(51) Int. Cl. H04L 5/00; H04W 48/14; H04W 48/20; H04W 72/231

(52) U.S. Cl. CPC H04L 5/0035; H04L 5/0094; H04W 48/14; H04W 48/20; H04W 72/231

(57) ABSTRACT

A terminal according to an embodiment disclosed herein may include the steps of: receiving a report request message including TRP selection criteria information from a first TRP communicating with the terminal through a first resource; checking whether first information to be inquired of a second TRP indicated in the received TRP selection criteria information is included; and transmitting a first request message requesting the first information in the received TRP selection criteria information to the second TRP when the first information to be inquired of a second TEP is included.

### TECHNICAL FIELD

The present disclosure relates to a communication technique, and more particularly, to a technique for selecting a transmission and reception point (TRP) and allocating resources thereto in a multi-TRP (mTRP) environment.

### BACKGROUND ART

A communication network (e.g. 5G communication network or 6G communication network) is being developed to provide enhanced communication services compared to the existing communication networks (e.g. long term evolution (LTE), LTE-Advanced (LTE-A), etc.). The 5G communication network (e.g. New Radio (NR) communication network) can support frequency bands both below 6 GHz and above 6 GHz. In other words, the 5G communication network can support both a frequency region 1 (FR1) and/or FR2 bands. Compared to the LTE communication network, the 5G communication network can support various communication services and scenarios. For example, usage scenarios of the 5G communication network may include enhanced Mobile BroadBand (eMBB), Ultra Reliable Low Latency Communication (URLLC), massive Machine Type Communication (mMTC), and the like.

The 6G communication network can support a variety of communication services and scenarios compared to the 5G communication network. The 6G communication network can meet the requirements of hyper-performance, hyper-bandwidth, hyper-space, hyper-precision, hyper-intelligence, and/or hyper-reliability. The 6G communication network can support diverse and wide frequency bands and can be applied to various usage scenarios such as terrestrial communication, non-terrestrial communication, sidelink communication, and the like.

Meanwhile, in 5G NR, a multi-transmission and reception point (MTRP) technique refers to a technique in which a gNB communicates with a terminal using multiple TRPs that are physically separated. The MTRP technique helps solve issues with reduced quality-of-service (QOS) for cell-edge terminals far from the base station and mitigates inter-cell interference from base stations in different cells. Additionally, it contributes to providing an alternative communication path in environments with limited non-line-of-sight (NLOS) paths, such as in millimeter wave bands.

In the current standards, the MTRP technique is categorized into a coherent joint transmission (CJT) scheme and a non-coherent joint transmission (NCJT) scheme. In the CJT scheme, TRPs cooperate in a synchronized manner based on a reliable backhaul link between base stations connected to the TRPs. On the other hand, in the NCJT scheme, scheduling, precoding matrix selection, modulation, and coding schemes are determined without coordination among the multiple TRPs supporting a single terminal.

Therefore, in an MTRP environment, a new resource allocation scheme that takes TRP synchronization into account is required when using the NCJT scheme.

### DISCLOSURE

### Technical Problem

The present disclosure is directed to providing a method and an apparatus for allocating resources in a mobile communication system with a multi-TRP (mTRP) environment.

### Technical Solution

A method of a terminal, according to an exemplary embodiment of the present disclosure, may comprise: receiving, from a first transmission and reception point (TRP) communicating with the terminal through a first resource, a report request message including TRP selection criteria information: determining whether the received TRP selection criteria information includes first information to be requested from a second TRP indicated by the received TRP selection criteria information: in response to determining that the first information to be requested from the second TRP is included in the received TRP selection criteria information, transmitting a first request message requesting the first information to the second TRP; and upon receiving a first response message including the first information from the second TRP, transmitting a second response message including the first information to the first TRP.

The method may further comprise: obtaining information on the first TRP from the first TRP and information on the second TRP from the second TRP, before receiving the report request message: transmitting the information on the first TRP to the second TRP; and transmitting the information on the second TRP to the first TRP, wherein the information on the first TRP and the information on the second TRP each include a TRP identifier (ID) and allocated frequency band information.

The first information may be information on a utilization of a specific resource of the second TRP.

The method may further comprise: in response to the TRP selection criteria information including a request for a reference signal received power (RSRP) of a synchronization signal block (SSB) transmitted by the second TRP, measuring an RSRP of an SSB of the second TRP, wherein the first response message may further include the RSRP of the SSB of the second TRP.

The method may further comprise: receiving, from the first TRP, user data transmission indication information including a TRP ID; in response to the TRP ID indicating the first TRP, receiving, from the first TRP, allocation information of a second resource different from the first resource; and receiving user data based on the allocation information of the second resource.

The method may further comprise: receiving, from the first TRP, user data transmission indication information including an ID of the second TRP and information related to a communication link of the first resource; transmitting, to the second TRP, the ID of the second TRP and the information related to the communication link of the first resource: receiving, from the second TRP, allocation information of a second resource based on the information related to the communication link of the first resource; and receiving user data based on the allocation information of the second resource.

The allocation information of the second resource may indicate a resource included in a same bandwidth part (BWP) as the first resource.

The information related to the communication link of the first resource may include information related to a physical resource block (PRB) between the first TRP and the terminal.

A terminal, according to an exemplary embodiment of the present disclosure, may comprise at least one processor, wherein the at least one processor causes the terminal to perform: receiving, from a first transmission and reception point (TRP) communicating with the terminal through a first resource, a report request message including TRP selection criteria information; determining whether the received TRP selection criteria information includes first information to be requested from a second TRP indicated by the received TRP selection criteria information; in response to determining that the first information to be requested from the second TRP is included in the received TRP selection criteria information, transmitting a first request message requesting the first information to the second TRP; and upon receiving a first response message including the first information from the second TRP, transmitting a second response message including the first information to the first TRP.

The at least one processor may further cause the terminal to perform: obtaining information on the first TRP from the first TRP and information on the second TRP from the second TRP, before receiving the report request message: transmitting the information on the first TRP to the second TRP; and transmitting the information on the second TRP to the first TRP, wherein the information on the first TRP and the information on the second TRP each include a TRP identifier (ID) and allocated frequency band information.

The first information may be information on a utilization of a specific resource of the second TRP.

The at least one processor may further cause the terminal to perform: in response to the TRP selection criteria information including a request for a reference signal received power (RSRP) of a synchronization signal block (SSB) transmitted by the second TRP, measuring an RSRP for an SSB of the second TRP, wherein the first response message further includes the RSRP for the SSB of the second TRP.

The at least one processor may further cause the terminal to perform: receiving, from the first TRP, user data transmission indication information including a TRP ID; in response to the TRP ID indicating the first TRP, receiving, from the first TRP, allocation information of a second resource different from the first resource; and receiving user data based on the allocation information of the second resource.

The at least one processor may further cause the terminal to perform: receiving, from the first TRP, user data transmission indication information including an ID of the second TRP and information related to a communication link of the first resource; transmitting, to the second TRP, the ID of the second TRP and the information related to the communication link of the first resource; receiving, from the second TRP, allocation information of a second resource based on the information related to the communication link of the first resource; and receiving user data based on the allocation information of the second resource.

The allocation information of the second resource may indicate a resource included in a same bandwidth part (BWP) as the first resource.

The information related to the communication link of the first resource may include information related to a physical resource block (PRB) between the first TRP and the terminal.

A method of a first transmission and reception point (TRP), according to an exemplary embodiment of the present disclosure, may comprise: in response to requiring additional user data transmission to a first terminal communicating with the first TRP using a first resource, transmitting, to the first terminal, a report request message including TRP selection criteria information obtained from a second TRP; receiving, from the first terminal, a response message including first information related to the TRP selection criteria information, which is obtained from the second TRP: selecting a TRP for transmitting user data to the first terminal based on the response message; and transmitting user data transmission indication information including an identifier of the selected TRP to the first terminal.

The method may further comprise: obtaining information on the first TRP from the first TRP and information on the second TRP from the second TRP, before transmitting the report request message: transmitting the information on the first TRP to the second TRP; and transmitting the information on the second TRP to the first TRP, wherein the information on the first TRP and the information on the second TRP each include a TRP identifier (ID) and allocated frequency band information.

The method may further comprise: in response to the selected TRP being the first TRP, allocating a second resource for transmitting additional user data to the first terminal; and transmitting the additional user data to the first terminal through the second resource.

The method may further comprise: in response to receiving, from a second terminal, information requesting a specific resource of the second TRP which is related to the TRP selection criteria information, generating information on a utilization of the specific resource; and transmitting, to the second terminal, the generated information on the utilization of the specific resource.

### Advantageous Effects

By applying the apparatus and method according to the present disclosure, an optimal TRP for transmitting data can be determined from among different TRPs supporting the single terminal in the MTRP NCJT environment, with involvement of the terminal. Furthermore, by determining the optimal TRP through the method of the present disclosure, additional user data can be smoothly and reliably transmitted to the terminal from the optimal TRP.

### DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a block diagram illustrating a first exemplary embodiment of communication nodes performing communication.

FIG. 4A is a block diagram illustrating a first exemplary embodiment of a transmission path.

FIG. 4B is a block diagram illustrating a first exemplary embodiment of a reception path.

FIG. 5 is a conceptual diagram illustrating a first exemplary embodiment of a system frame in a communication system.

FIG. 6 is a conceptual diagram illustrating a first exemplary embodiment of a subframe in a communication system.

FIG. 7 is a conceptual diagram illustrating a first exemplary embodiment of a slot in a communication system.

FIG. 8 is a conceptual diagram illustrating a first exemplary embodiment of a time-frequency resource in a communication system.

FIG. 9 is a signal flow diagram according to an exemplary embodiment of an operation in which a terminal respectively obtains information on TRPs from the TRPs in an MTRP NCJT environment.

FIG. 10 is a signal flow diagram according to an exemplary embodiment of information transfer for determining TRP selection criteria in an MTRP NCJT environment.

FIG. 11 is a signal flow diagram according to an exemplary embodiment in which a terminal transmits TRP selection criteria information obtained from another TRP to a serving TRP in an MTRP NCJT environment.

FIG. 12 is a signal flow diagram according to an exemplary embodiment of the present disclosure in which a TRP A selects an optimal TRP based on SSB RSRP and/or frequency resource utilization in an MTRP NCJT environment.

FIG. 13 is a signal flow diagram according to an exemplary embodiment for a case where a TRP A is selected for additional user data transmission in an MTRP NCJT environment.

FIG. 14 is a signal flow diagram according to an exemplary embodiment for a case where a TRP B is selected for additional user data in transmission an MTRP NCJT environment.

FIG. 15 is a signal flow diagram according to an exemplary embodiment for a case where a TRB B, which is a non-serving cell, is determined as a TRP transmitting additional user data in an MTRP NCJT environment.

FIG. 16 is a signal flow diagram according to an exemplary embodiment for a case where a TRB B, which is a non-serving cell, transmits additional user data in an MTRP NCJT environment.

FIG. 17 is a block diagram illustrating an overall procedure for transmitting additional user data in an MTRP NCJT environment.

FIG. 18 is an overall signal flow diagram for additional user data transmission in an MTRP NCJT environment.

### MODE FOR INVENTION

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

In the present disclosure, ‘(re) transmission’ may refer to ‘transmission’, ‘retransmission’, or ‘transmission and retransmission’, ‘(re) configuration’ may refer to ‘configuration’, ‘reconfiguration’, or ‘configuration and reconfiguration’, ‘(re) connection’ may refer to ‘connection’, ‘reconnection’, or ‘connection and reconnection’, and ‘(re) access’ may refer to ‘access’, ‘re-access’, or ‘access and re-access’.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, exemplary embodiments of the present disclosure will be described in detail with reference to the accompanying drawings. In describing the disclosure, to facilitate the entire understanding of the disclosure, like numbers refer to like elements throughout the description of the figures and the repetitive description thereof will be omitted. The operations according to the exemplary embodiments described explicitly in the present disclosure, as well as combinations of the exemplary embodiments, extensions of the exemplary embodiments, and/or variations of the exemplary embodiments, may be performed. Some operations may be omitted, and a sequence of operations may be altered.

Even when a method (e.g. transmission or reception of a signal) to be performed at a first communication node among communication nodes is described in exemplary embodiments, a corresponding second communication node may perform a method (e.g. reception or transmission of the signal) corresponding to the method performed at the first communication node. That is, when an operation of a user equipment (UE) is described, a base station corresponding thereto may perform an operation corresponding to the operation of the UE. Conversely, when an operation of a base station is described, a corresponding UE may perform an operation corresponding to the operation of the base station.

The base station may be referred to by various terms such as NodeB, evolved NodeB, next generation node B (gNodeB), gNB, device, apparatus, node, communication node, base transceiver station (BTS), radio remote head (RRH), transmission reception point (TRP), radio unit (RU), road side unit (RSU), radio transceiver, access point, access node, and the like. The user equipment (UE) may be referred to by various terms such as terminal, device, apparatus, node, communication node, end node, access terminal, mobile terminal, station, subscriber station, mobile station, portable subscriber station, on-board unit (OBU), and the like.

In the present disclosure, signaling may be one or a combination of two or more of higher layer signaling, MAC signaling, and physical (PHY) signaling. A message used for higher layer signaling may be referred to as a ‘higher layer message’ or ‘higher layer signaling message’. A message used for MAC signaling may be referred to as a ‘MAC message’ or ‘MAC signaling message’. A message used for PHY signaling may be referred to as a ‘PHY message’ or ‘PHY signaling message’. The higher layer signaling may refer to an operation of transmitting and receiving system information (e.g. master information block (MIB), system information block (SIB)) and/or an RRC message. The MAC signaling may refer to an operation of transmitting and receiving a MAC control element (CE). The PHY signaling may refer to an operation of transmitting and receiving control information (e.g. downlink control information (DCI), uplink control information (UCI), or sidelink control information (SCI)).

In the present disclosure, ‘configuration of an operation (e.g. transmission operation)’ may refer to signaling of configuration information (e.g. information elements, parameters) required for the operation and/or information indicating to perform the operation. ‘configuration of information elements (e.g. parameters)’ may refer to signaling of the information elements. In the present disclosure, ‘signal and/or channel’ may refer to signal, channel, or both signal and channel, and ‘signal’ may be used to mean ‘signal and/or channel’.

A communication network to which exemplary embodiments are applied is not limited to that described below, and the exemplary embodiments may be applied to various communication networks (e.g. 4G communication networks, 5G communication networks, and/or 6G communication networks). Here, ‘communication network’ may be used interchangeably with a term ‘communication system’.

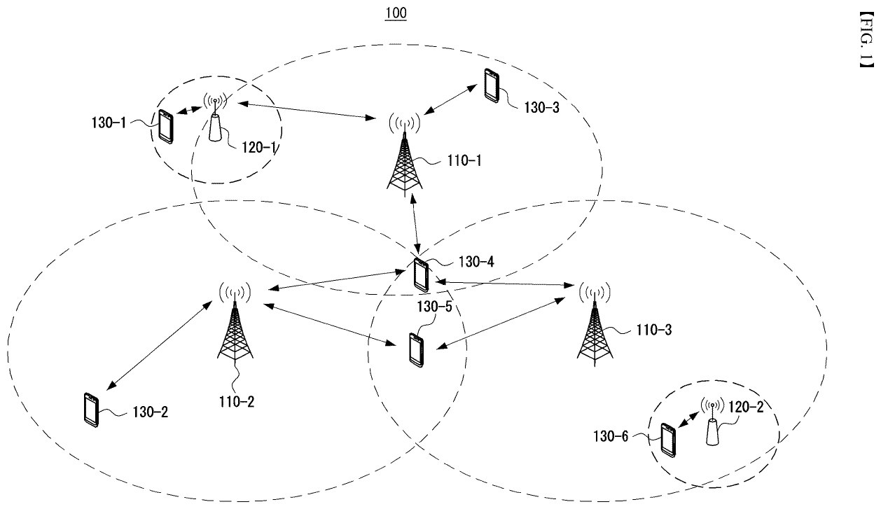

FIG. 1 is a conceptual diagram illustrating a first exemplary embodiment of a communication system.

As shown in FIG. 1, a communication system 100 may comprise a plurality of communication nodes 110-1, 110-2, 110-3, 120-1, 120-2, 130-1, 130-2, 130-3, 130-4, 130-5, and 130-6. In addition, the communication system 100 may further include a core network (e.g. a serving gateway (S-GW), a packet data network (PDN) gateway (P-GW), a mobility management entity (MME). When the communication system 100 is a 5G communication (e.g. NR system), the core network may include an access and mobility management function (AMF), a user plane function (UPF), a session management function (SMF), and the like.

The plurality of communication nodes 110 to 130 may support communication protocols (e.g. LTE communication protocol, LTE-A communication protocol, NR communication protocol, etc.) specified in 3^{rd} generation partnership project (3GPP) standards. The plurality of communication nodes 110 to 130 may support a code division multiple access (CDMA) technique, a wideband CDMA (WCDMA) technique, a time division multiple access (TDMA) technique, a frequency division multiple access (FDMA) technique, an orthogonal frequency division multiplexing (OFDM) technique, a filtered OFDM technique, a cyclic prefix OFDM (CP-OFDM) technique, a discrete Fourier transform spread OFDM (DFT-s-OFDM) technique, an orthogonal frequency division multiple access (OFDMA) technique, a single carrier FDMA (SC-FDMA) technique, a non-orthogonal multiple access (NOMA) technique, a generalized frequency division multiplexing (GFDM) technique, a filter bank multi-carrier (FBMC) technique, a universal filtered multi-carrier (UFMC) technique, a space division multiple access (SDMA) technique, or the like. Each of the plurality of communication node may have the following structure.

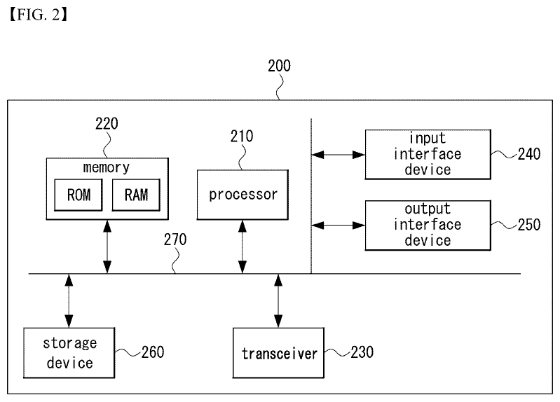

FIG. 2 is a block diagram illustrating a first exemplary embodiment of a communication node constituting a communication system.

As shown in FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, evolved Node-B (eNB), gNB, advanced base station (ABS), high reliability-base station (HR-BS), base transceiver station (BTS), radio base station, radio transceiver, access point, access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (COMP) transmission, carrier aggregation (CA) transmission, transmission in an unlicensed band, sidelink communication (e.g. device-to-device (D2D) communication, proximity services (ProSe)), Internet of Things (IoT) communication, dual connectivity (DC), and/or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control sidelink communications between the fourth terminal 130-4 and the fifth terminal 130-5, and thus the fourth terminal 130-4 and the fifth terminal 130-5 may perform the sidelink communications under control of the second base station 110-2 and the third base station 110-3, respectively.

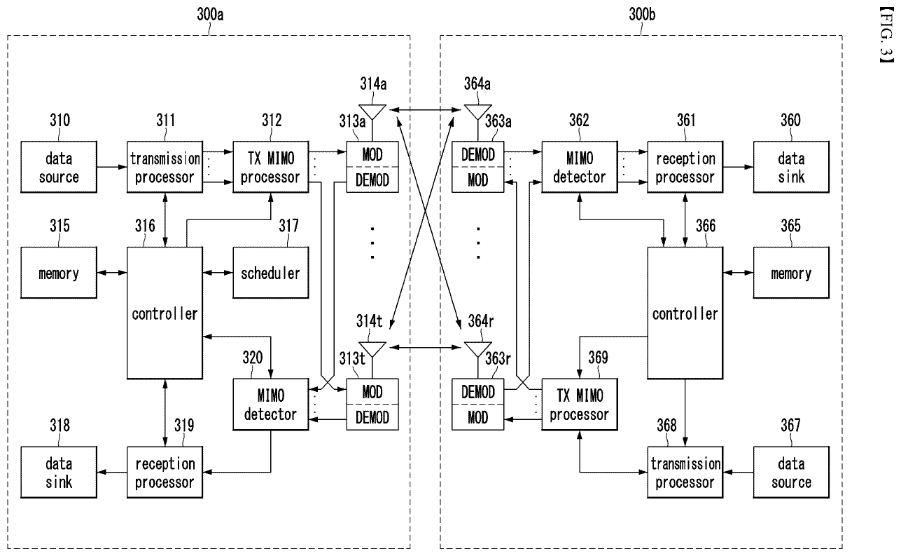

Meanwhile, communication nodes that perform communications in the communication network may be configured as follows. A communication node shown in FIG. 3 may be a specific exemplary embodiment of the communication node shown in FIG. 2.

FIG. 3 is a block diagram illustrating a first exemplary embodiment of communication nodes performing communication.

As shown in FIG. 3, each of a first communication node 300a and a second communication node 300b may be a base station or UE. The first communication node 300a may transmit a signal to the second communication node 300b. A transmission processor 311 included in the first communication node 300a may receive data (e.g. data unit) from a data source 310. The transmission processor 311 may receive control information from a controller 316. The control information may include at least one of system information, RRC configuration information (e.g. information configured by RRC signaling), MAC control information (e.g. MAC CE), or PHY control information (e.g. DCI, SCI).

The transmission processor 311 may generate data symbol(s) by performing processing operations (e.g. encoding operation, symbol mapping operation, etc.) on the data. The transmission processor 311 may generate control symbol(s) by performing processing operations (e.g. encoding operation, symbol mapping operation, etc.) on the control information. In addition, the transmission processor 311 may generate synchronization/reference symbol(s) for synchronization signals and/or reference signals.

A Tx MIMO processor 312 may perform spatial processing operations (e.g. precoding operations) on the data symbol(s), control symbol(s), and/or synchronization/reference symbol(s). An output (e.g. symbol stream) of the Tx MIMO processor 312 may be provided to modulators (MODs) included in transceivers 313a to 313t. The modulator may generate modulation symbols by performing processing operations on the symbol stream, and may generate signals by performing additional processing operations (e.g. analog conversion operations, amplification operation, filtering operation, up-conversion operation, etc.) on the modulation symbols. The signals generated by the modulators of the transceivers 313a to 313t may be transmitted through antennas 314a to 314t.

The signals transmitted by the first communication node 300a may be received at antennas 364a to 364r of the second communication node 300b. The signals received at the antennas 364a to 364r may be provided to demodulators (DEMODs) included in transceivers 363a to 363r. The demodulator (DEMOD) may obtain samples by performing processing operations (e.g. filtering operation, amplification operation, down-conversion operation, digital conversion operation, etc.) on the signals. The demodulator may perform additional processing operations on the samples to obtain symbols. A MIMO detector 362 may perform MIMO detection operations on the symbols. A reception processor 361 may perform processing operations (e.g. de-interleaving operation, decoding operation, etc.) on the symbols. An output of the reception processor 361 may be provided to a data sink 360 and a controller 366. For example, the data may be provided to the data sink 360 and the control information may be provided to the controller 366.

On the other hand, the second communication node 300b may transmit signals to the first communication node 300a. A transmission processor 368 included in the second communication node 300b may receive data (e.g. data unit) from a data source 367 and perform processing operations on the data to generate data symbol(s). The transmission processor 368 may receive control information from the controller 366 and perform processing operations on the control information to generate control symbol(s). In addition, the transmission processor 368 may generate reference symbol(s) by performing processing operations on reference signals.

A Tx MIMO processor 369 may perform spatial processing operations (e.g. precoding operations) on the data symbol(s), control symbol(s), and/or reference symbol(s). An output (e.g. symbol stream) of the Tx MIMO processor 369 may be provided to modulators (MODs) included in the transceivers 363a to 363t. The modulator may generate modulation symbols by performing processing operations on the symbol stream, and may generate signals by performing additional processing operations (e.g. analog conversion operation, amplification operation, filtering operation, up-conversion operations) on the modulation symbols. The signals generated by the modulators of the transceivers 363a to 363t may be transmitted through the antennas 364a to 364t.

The signals transmitted by the second communication node 300b may be received at the antennas 314a to 314r of the first communication node 300a. The signals received at the antennas 314a to 314r may be provided to demodulators (DEMODs) included in the transceivers 313a to 313r. The demodulator may obtain samples by performing processing operations (e.g. filtering operation, amplification operation, down-conversion operation, digital conversion operation) on the signals. The demodulator may perform additional processing operations on the samples to obtain symbols. A MIMO detector 320 may perform a MIMO detection operation on the symbols. The reception processor 319 may perform processing operations (e.g. de-interleaving operation, decoding operation, etc.) on the symbols. An output of the reception processor 319 may be provided to a data sink 318 and the controller 316. For example, the data may be provided to the data sink 318 and the control information may be provided to the controller 316.

Memories 315 and 365 may store the data, control information, and/or program codes. A scheduler 317 may perform scheduling operations for communication. The processors 311, 312, 319, 361, 368, and 369 and the controllers 316 and 366 shown in FIG. 3 may be the processor 210 shown in FIG. 2, and may be used to perform methods described in the present disclosure.

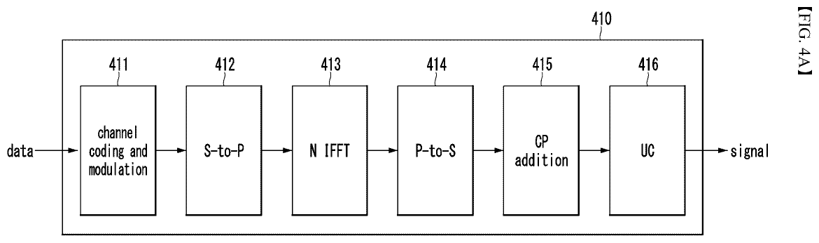

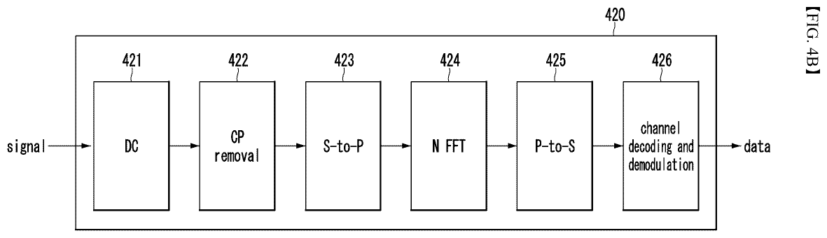

FIG. 4A is a block diagram illustrating a first exemplary embodiment of a transmission path, and FIG. 4B is a block diagram illustrating a first exemplary embodiment of a reception path.

As shown in FIGS. 4A and 4B, a transmission path 410 may be implemented in a communication node that transmits signals, and a reception path 420 may be implemented in a communication node that receives signals. The transmission path 410 may include a channel coding and modulation block 411, a serial-to-parallel (S-to-P) block 412, an N-point inverse fast Fourier transform (N-point IFFT) block 413, a parallel-to-serial (P-to-S) block 414, a cyclic prefix (CP) addition block 415, and up-converter (UC) 416. The reception path 420 may include a down-converter (DC) 421, a CP removal block 422, an S-to-P block 423, an N-point FFT block 424, a P-to-S block 425, and a channel decoding and demodulation block 426. Here, N may be a natural number.

In the transmission path 410, information bits may be input to the channel coding and modulation block 411. The channel coding and modulation block 511 may perform a coding operation (e.g. low-density parity check (LDPC) coding operation, polar coding operation, etc.) and a modulation operation (e.g. Quadrature Phase Shift Keying (OPSK), Quadrature Amplitude Modulation (QAM), etc.) on the information bits. An output of the channel coding and modulation block 411 may be a sequence of modulation symbols.

The S-to-P block 412 may convert frequency domain modulation symbols into parallel symbol streams to generate N parallel symbol streams. N may be the IFFT size or the FFT size. The N-point IFFT block 413 may generate time domain signals by performing an IFFT operation on the N parallel symbol streams. The P-to-S block 414 may convert the output (e.g., parallel signals) of the N-point IFFT block 413 to serial signals to generate the serial signals.

The CP addition block 415 may insert a CP into the signals. The UC 416 may up-convert a frequency of the output of the CP addition block 415 to a radio frequency (RF) frequency. Further, the output of the CP addition block 415 may be filtered in baseband before the up-conversion.

The signal transmitted from the transmission path 410 may be input to the reception path 420. Operations in the reception path 420 may be reverse operations for the operations in the transmission path 410. The DC 421 may down-convert a frequency of the received signals to a baseband frequency. The CP removal block 422 may remove a CP from the signals. The output of the CP removal block 422 may be serial signals. The S-to-P block 423 may convert the serial signals into parallel signals. The N-point FFT block 424 may generate N parallel signals by performing an FFT algorithm. The P-to-S block 425 may convert the parallel signals into a sequence of modulation symbols. The channel decoding and demodulation block 426 may perform a demodulation operation on the modulation symbols and may restore data by performing a decoding operation on a result of the demodulation operation.

In FIGS. 4A and 4B, discrete Fourier transform (DFT) and inverse DFT (IDFT) may be used instead of FFT and IFFT. Each of the blocks (e.g. components) in FIGS. 4A and 4B may be implemented by at least one of hardware, software, or firmware. For example, some blocks in FIGS. 4A and 4B may be implemented by software, and other blocks may be implemented by hardware or a combination of hardware and software. In FIGS. 4A and 4B, one block may be subdivided into a plurality of blocks, a plurality of blocks may be integrated into one block, some blocks may be omitted, and blocks supporting other functions may be added.

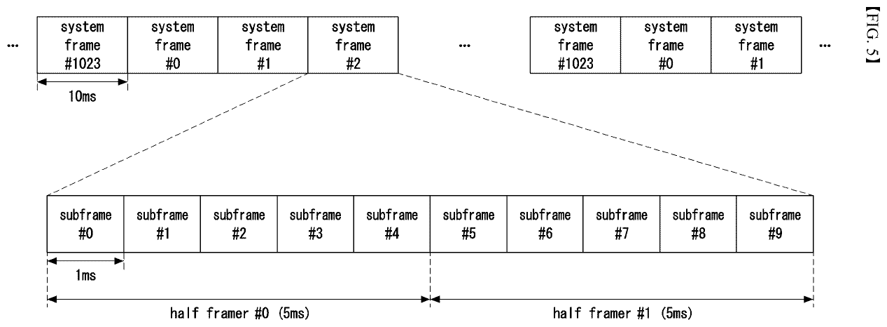

FIG. 5 is a conceptual diagram illustrating a first exemplary embodiment of a system frame in a communication system.

As shown in FIG. 5, time resources in the communication system may be divided on a frame basis. For example, system frames of the communication system may be configured continuously in the time domain. The length of the system frame may be 10 millisecond (ms). A system frame number (SFN) may be set to one of #0 to #1023. In this case, 1024 system frames may be repeated on the time domain of the communication system. For example, an SFN of a system frame after the system frame #1023 may be #0.

One system frame may include two half frames. The length of one half frame may be 5 ms. A half frame located at a starting region of the system frame may be referred to as ‘half frame #0’, and a half frame located at an ending region of the system frame may be referred to as ‘half frame #1’. One system frame may include 10 subframes. The length of one subframe may be 1 ms. 10 subframes within one system frame may be referred to as subframes #0-#9.

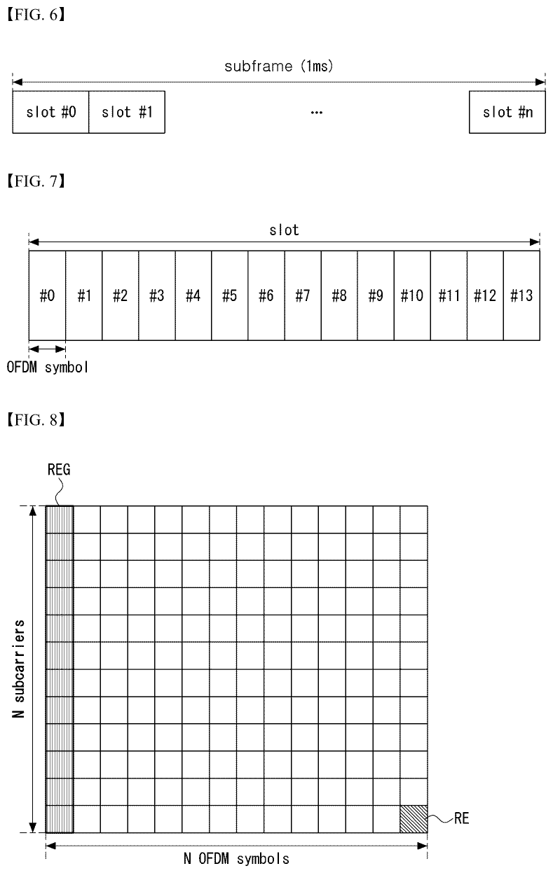

FIG. 6 is a conceptual diagram illustrating a first exemplary embodiment of a subframe in a communication system.

As shown in FIG. 6, one subframe may include n slots, and n may be a natural number. Accordingly, one subframe may consist of one or more slots.

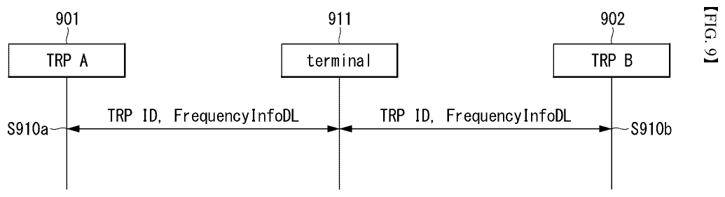

FIG. 7 is a conceptual diagram illustrating a first exemplary embodiment of a slot in a communication system.

As shown in FIG. 7, one slot may include one or more symbols. For example, one slot shown in FIG. 7 may include 14 symbols. The length of slot may vary according to the number of symbols included in a slot and the length of symbol. Alternatively, the length of slot may vary according to a numerology.

The numerology applied to physical signals and channels in a communication system may be variable. The numerology may be adjusted to meet various technical requirements of the communication system. In a communication system where a cyclic prefix (CP)-based OFDM waveform technology is applied, the numerology may include a subcarrier spacing and a CP length (or CP type). Table 1 may illustrate a first exemplary embodiment of a method for configuring numerologies for a CP-OFDM-based communication system. Depending on a frequency band in which the communication system operates, at least some of the numerologies in Table 1 may be supported. Additionally, the communication system may support numerologies not listed in Table 1.

TABLE 1

| Subcarrier | 15 | 30 | 60 | 120 | 240 | 480 |
|---|---|---|---|---|---|---|
| spacing | kHz | kHz | kHz | kHz | kHz | kHz |
| OFDM symbol | 66.7 | 33.3 | 16.7 | 8.3 | 4.2 | 2.1 |
| length [μs] | | | | | | |
| CP length [us] | 4.76 | 2.38 | 1.19 | 0.60 | 0.30 | 0.15 |
| Number of | 14 | 28 | 56 | 112 | 224 | 448 |
| OFDM symbols | | | | | | |
| within 1 ms | | | | | | |

When a subcarrier spacing is 15 kHz (e.g. μ=0), the length of slot may be 1 ms. In this case, one system frame may include 10 slots. When a subcarrier spacing is 30 kHz (e.g. μ=1), the length of slot may be 0.5 ms. In this case, one system frame may include 20 slots.

When a subcarrier spacing is 60 kHz (e.g. μ=2), the length of slot may be 0.25 ms. In this case, one system frame may include 40 slots. When a subcarrier spacing is 120 kHz (e.g. μ=3), the length of slot may be 0.125 ms. In this case, one system frame may include 80 slots. When a subcarrier spacing is 240 kHz (e.g. μ=4), the length of slot may be 0.0625 ms. In this case, one system frame may include 160 slots.

The symbol may be configured as a downlink (DL) symbol, flexible (FL) symbol, or uplink (UL) symbol. A slot composed of only DL symbols may be referred to as a ‘DL slot’, a slot composed of only FL symbols may be referred to as a ‘FL slot’, and a slot composed of only UL symbols may be referred to as a ‘UL slot’. A slot format may be semi-statically configured through higher-layer signaling (e.g. RRC signaling). Information indicating a semi-static slot format may be included in system information, and the semi-static slot format may be configured cell-specifically. Additionally, a semi-static slot format may be further configured for each terminal through terminal-specific higher-layer signaling (e.g. RRC signaling). Flexible symbols in the cell-specific slot format may be overridden to be downlink symbols or uplink symbols through terminal-specific higher-layer signaling. Furthermore, a slot format may be dynamically indicated through physical layer signaling (e.g. slot format indicator (SFI) included in DCI). The semi-statically configured slot format may be overridden by the dynamically indicated slot format. For example, flexible symbols configured semi-statically may be overridden to be downlink symbols or uplink symbols by the SFI.

Reference signals may include Channel State Information-Reference Signal (CSI-RS), Sounding Reference Signal (SRS), Demodulation-Reference Signal (DM-RS), and Phase Tracking-Reference Signal (PT-RS). Channels may include Physical Broadcast Channel (PBCH), Physical Downlink Control Channel (PDCCH), Physical Downlink Shared Channel (PDSCH), Physical Uplink Control Channel (PUCCH), PUSCH (Physical Uplink Shared Channel), PSCCH (Physical Sidelink Control Channel), and PSSCH (Physical Sidelink Shared Channel). In the present disclosure, a control channel may refer to PDCCH, PUCCH, or PSCCH, and a data channel may refer to PDSCH, PUSCH, or PSSCH.

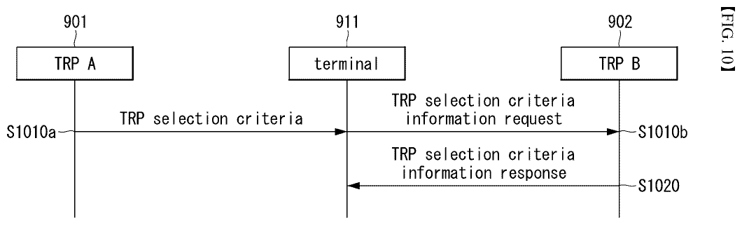

FIG. 8 is a conceptual diagram illustrating a first exemplary embodiment of a time-frequency resource in a communication system.

As shown FIG. 8, a resource composed of one OFDM symbol on the time axis and one subcarrier on the frequency axis may be defined as a ‘resource element (RE)’. A resource composed of one OFDM symbol on the time axis and K subcarriers on the frequency axis may be defined as a ‘resource element group (REG)’. The REG may include K REs. The REG may be used as a basic unit of resource allocation in the frequency domain. K may be a natural number. For example, K may be 12. N may be a natural number. In the slot shown in FIG. 7, N may be 14. N OFDM symbols may be used as a basic unit of resource allocation in the time domain.

In the present disclosure, an RB may refer to a common RB (CRB). Alternatively, an RB may refer to a physical RB (PRB) or a virtual RB (VRB). In a communication system, a CRB may refer to an RB that constitutes a set of contiguous RBs (e.g. a common RB grid) based on a reference frequency (e.g. point A). A carrier and/or bandwidth part may be mapped onto the common RB grid. That is, a carrier and/or bandwidth part may be configured with CRB(s). The RBs or CRBs that constitute a bandwidth part may be referred to as PRBs, and a CRB index may be appropriately converted to a PRB index within the bandwidth part.

Downlink data may be transmitted through a PDSCH. A base station may transmit configuration information (e.g. scheduling information) of the PDSCH to a terminal through a PDCCH. The terminal may obtain the configuration information of the PDSCH by receiving the PDCCH (e.g. Downlink Control Information (DCI)). For example, the configuration information of the PDSCH may include a Modulation Coding Scheme (MCS) used for transmission/reception of the PDSCH, time resource information of the PDSCH, frequency resource information of the PDSCH, and feedback resource information for the PDSCH. The PDSCH may refer to a radio resource where the downlink data is transmitted and received. Alternatively, the PDSCH may refer to the downlink data itself. The PDCCH may refer to a radio resource where the downlink control information (e.g. DCI) is transmitted and received. Alternatively, the PDCCH may refer to the downlink control information itself.

The terminal may perform a monitoring operation for the PDCCH to receive the PDSCH transmitted from the base station. The base station may notify the terminal of configuration information for the PDCCH monitoring operation using a higher-layer message (e.g. Radio Resource Control (RRC) message). The configuration information for the PDCCH monitoring operation may include Control Resource Set (CORESET) information and search space information.

The CORESET information may include PDCCH DMRS information, PDCCH precoding information, and PDCCH occasion information, and the like. A PDCCH DMRS may be a DMRS used for demodulating a PDCCH. A PDCCH occasion refers to a region where a PDCCH may potentially exist, meaning it is a region where DCI can be transmitted. A PDCCH occasion may also be referred to as a PDCCH candidate. The PDCCH occasion information may include time resource information and frequency resource information for the PDCCH occasion. In the time domain, the length of the PDCCH occasion may be indicated in symbol units. In the frequency domain, the size of the PDCCH occasion can be indicated in RB units (e.g. in PRB units or CRB units).

The search space information may include a CORESET identifier (ID) associated with a search space, a periodicity of PDCCH monitoring, and/or an offset of PDCCH monitoring. The periodicity and offset of PDCCH monitoring may each be indicated in slot units. Additionally, the search space information may further include an index of a symbol where the PDCCH monitoring operation starts.

The base station may configure Bandwidth Part(s) (BWP(s)) for downlink communication. The BWP(s) may be configured differently for each terminal. The base station may notify the terminal of BWP configuration information using higher-layer signaling. The higher-layer signaling may refer to a transmission operation of system information and/or a transmission operation of RRC message(s). The number of BWPs configured for a single terminal may be one or more. The terminal may receive the BWP configuration information from the base station and identify the configured BWP(s) based on the received configuration information. When multiple BWPs are configured for downlink communication, the base station may activate one or more BWPs from among the multiple BWPs. The base station may transmit configuration information of the activated BWP(s) to the terminal using at least one of higher-layer signaling, Medium Access Control (MAC) Control Element (CE), or DCI. The base station may perform downlink communication using the activated BWP(s). The terminal may identify the activated BWP(s) by receiving the configuration information from the base station and perform downlink reception operations on the activated BWP(s).

Meanwhile, in 5G NR, a multi-transmission and reception point (MTRP) technique refers to a technique in which a gNB communicates with a terminal using multiple TRPs that are physically separated. The MTRP technique helps solve issues with reduced quality-of-service (QOS) for cell-edge terminals far from the base station and mitigates inter-cell interference from base stations in different cells. Additionally, it contributes to providing an alternative communication path in environments with limited non-line-of-sight (NLOS) paths, such as in millimeter wave bands.

In the current standards, the MTRP technique is categorized into a coherent joint transmission (CJT) scheme and a non-coherent joint transmission (NCJT) scheme. In the CJT scheme, TRPs cooperate in a synchronized manner based on a reliable backhaul link between base stations connected to the TRPs. On the other hand, in the NCJT scheme, scheduling, precoding matrix selection, modulation, and coding schemes are determined without coordination among the multiple TRPs supporting a single terminal.

Therefore, in order to perform efficient communication while controlling interference between TRPs, a communication technique that considers different TRPs is required. In this regard, the 3GPP has agreed that a transmission time, transmission periodicity, and transmission power of synchronization signal blocks (SSBs) of a non-serving cell need to be controlled during an inter-cell MTRP operation process. However, the agreement on such resource allocation is limited to SSBs, and there has been no discussion yet on a situation where information is transmitted after a cell search process. Furthermore, when a terminal receives signals from multiple TRPs, only a single bandwidth part (BWP) can be activated in the terminal. However, when utilizing the NCJT scheme according to the current standards, since multiple TRPs support a single terminal without cooperation, it is not possible to guarantee that subcarrier spacings (SCSs), cyclic prefixes, Fast Fourier Transform (FFT) sizes, and frequency bands of signals transmitted to the same terminal are consistent. Therefore, when using the NCJT scheme in the MTRP environment, a new resource allocation technique that considers synchronization between TRPs is required.

In addition, the 3GPP is discussing various situations in which MTRP should be considered. For example, it has been agreed that all intra- and inter-cell MTRP schemes specified in an unified TCI framework extension should be considered. In addition, it has been agreed that the existing TCI field of DCI format 1_1/1_2 is used to indicate multiple joint/DL/UL TCI states for a CC/BWP or a CC/BWP set of a CC list, at least in the unified TCI framework extension for single DCI-based MTRP. In addition, it has been agreed that further solutions for TCI state updates should be considered to extend the unified TCI framework for M-DCI based MTRP.

The above-described agreements do not provide specific methods for MTRP support.

In 5G NR, which has been standardized so far, communication procedures utilizing MTRP are supported to improve the performance and efficiency of MIMO.

The CJT or NCJT scheme in the MTRP technique may be determined according to an environment of a cell where the current TRPs exist, backhaul link connectivity, and/or the like. In addition, depending on which scheme is selected between the CJT and NCJT scheme in the MTRP technique, it may be determined whether multiple TRPs cooperate to support one terminal (CJT scheme) or whether each TRP independently supports one terminal (NCJT scheme).

The present disclosure assumes a situation where multiple TRPs support a single terminal in the MTRP NCJT environment. Specifically, the present disclosure considers a case in which additional user data is to be transmitted to the terminal when the terminal is currently communicating with one TRP the corresponds to a serving cell. In the environment considered in the present, it may be impossible to determine which TRP to select and which resources to allocate for communication between a selected TRP and the terminal based only on information on a physical cell ID (PCI) and SSBs of a non-serving cell, which has been agreed upon in the current 5G NR standards. In particular, when one TRP is communicating with one terminal and wishes to transmit additional user data to the terminal, there is a physical constraint on receiving the additional user data from a TRP other than the existing TRP due to the characteristics of the terminal. In addition, during the process of allocating additional resources, when the existing TRP cannot allocate resources, or when a new TRP can provide better additional resources than the existing TRP, the new TRP is unable to allocate resources to the terminal due to the lack of cooperation between the TRPs under the current standards.

Therefore, when it is desired to transmit additional user data to the terminal, an information transfer procedure is required for cooperation between the currently communicating TRP and another TRP that can serve the terminal. For a situation where one TRP corresponding to a serving cell is communicating with one terminal in the MTRP NCJT environment, the present disclosure provides a method for allocating additional resources to communication between the existing TRP and the terminal and performing additional transmission when wishing to transmitting additional user data to the terminal. In addition, for the situation where one TRP corresponding to a serving cell is communicating with one terminal in the MTRP NCJT environment, the present disclosure provides a method for the new TRP to perform additional transmission. In addition, the present disclosure provides criteria and procedures for selecting one of the above two schemes. Furthermore, the present disclosure provides a new resource allocation method that solves the problem that multiple TRPs previously could not support one terminal by transmitting information so that the new TRP can set an appropriate SCS, cyclic prefix, FFT size, frequency band, etc. by considering the communication link between the existing TRP and the terminal when the new TRP is selected.

In the present disclosure described below, description will be made considering a situation in which two TRPs (e.g. TRP A and TRP B) support one terminal in the MTRP NCJT environment. However, the present disclosure may also be applied to a situation in which three or more TRPs support one terminal.

In the present disclosure, a case is considered where additional user data is to be transmitted to the terminal when the terminal is communicating with one TRP (TRP A). For this case, the present disclosure proposes a technique for selecting a TRP to perform additional user data transmission among the TRP A currently communicating with the terminal and the TRP B not currently communicating with the terminal, and allocating resources in consideration of the communication link with the existing TRP A. Specifically, the present disclosure may provide a method of configuring criteria for selecting an additional TRP to transmit user data, a process (procedure) for exchanging information on performances related thereto, a method for selecting an optimal TRP for additional user data transmission based on the performances, and a method for allocating additional resources to the selected TRP.

First, when the terminal is receiving information (or user data) from the TRP A corresponding to a serving cell and it is required to transmit additional user data to the terminal, the terminal may transmit information on the performance of the TRP B, which is received from the TRP B corresponding to a non-serving cell, to the TRP A. Then, TRP A may compare its own performance with the performance of the TRP B to determine which TRP to additionally transmit information. If the performance of TRP A is determined to be better, a TRP ID of the selected TRP A may be transmitted to the terminal as information for TRP identification, and information on additional resources may be transmitted together.

On the other hand, if the TRP A determines that the performance of the TRP B is better according to the result of comparing its own performance with that of the TRP B and determining which TRP to transmit additional information, a TRP ID of the selected TRP B may be transmitted to the terminal as information for TRP identification. In addition, the TRP A may transmit information on a SCS, cyclic prefix, FFT size, etc. currently used by the TRP A to the terminal. Then, the terminal may deliver the information on the SCS, cyclic prefix, FFT size, etc. received from the TRP A to the TRP B. The TRP B receiving the information on the SCS, cyclic prefix, FFT size, etc. used by the TRP A from the terminal may allocate resources for transmitting additional user data to the terminal based on the information received from the terminal.

In the techniques according to the present disclosure, a transmission scheme may vary depending on an RRC connection state between the terminal and the TRP B that is a non-serving cell. When the terminal is RRC-connected with the TRP B that is a non-serving cell, the transmission may be performed in the same manner as in the TRP A that is a serving cell. The terminal may be assumed to be a multi-connected state in which it is RRC-connected with the TRP A and TRP B (i.e. multiple TRPs).

If multiple connections are not possible, the terminal may establish a temporary RRC connection with a base station of the non-serving cell by transmitting an RRC connection establishment request message to the base station of the non-serving cell. To notify establishment of the temporary RRC connection, the terminal may utilize an RRC connection establishment cause included in the RRC connection establishment request message. For example, the terminal may transmit the RRC connection establishment cause to the base station of the non-serving cell, indicating that the RRC connection establishment is for the purpose of transmitting information on the TRP of the serving cell. Through this procedure, the terminal may establish a temporary RRC connection with the base station of the non-serving cell.

When a temporary RRC connection is established with the base station of the non-serving cell in the above-described manner, the terminal may transmit information on the TRP of the serving cell to the base station of the non-serving cell. Then, the base station of the non-serving cell may proceed with connection release by transmitting RRC connection suspend information for releasing the temporary RRC connection with the terminal to the terminal after receiving the information on the TRP of the serving cell.

In the connection release process, the base station of the non-serving cell may instruct the terminal to perform periodical reporting related to MTRP operations through an RRC connection release message. For example, the base station of the non-serving cell may instruct the terminal to transmit the corresponding information when there is a change in the configuration of the serving cell or an aperiodic change in the configuration of the serving cell. The terminal receiving such the instructing information may establish an RRC connection with the non-serving cell at a specific periodicity or whenever it recognizes a change in the configuration of the serving cell, after the RRC connection with the base station of the non-serving cell is released. Then, the terminal may repeat the process of transmitting the configuration of the serving cell to the non-serving cell and then releasing the RRC connection. These RRC connection establishment and release procedures may include procedures such as RRC resume request, RRC resume, and RRC resume complete.

On the other hand, when the terminal is in the RRC inactive state with the TRP B, they cannot proceed in the same manner as the RRC signaling scheme of the TRP A, and may utilize a signaling scheme that is possible in the RRC inactive state. For example, when the terminal is in the RRC inactive with the TRP B, information such as SN RRC reconfiguration, SN RRC reconfiguration complete, SN measurement report, and SN UE assistance information may be transmitted through an SRB3. The necessary procedures for SRB3 operations may be performed based on a process in which the terminal notifies the serving cell of a non-serving cell that will support MTRP by transmitting information on the non-serving cell, a process in which the serving cell configures dual connectivity between the terminal and the non-serving cell, and a process in which an SRB is established between the non-serving cell and the terminal. In this case, the relevant procedures may be performed through SgNB addition request, SgNB addition request acknowledge, RRC connection reconfiguration, RRC connection reconfiguration complete, and SgNB reconfiguration complete messages in the existing SRB3 establishment process. As another example, the relevant procedures may be performed using new parameters. The present disclosure described below assumes that the above-described procedures for SRB3 establishment have been performed when the TRP B and the terminal are in the RRC inactive state.

In the following description, a terminal may refer to or be interchangeable with a user equipment (UE), and a UE may refer to or be interchangeable with a terminal. In addition, TRPs described below may have communication areas overlapping at least partially.

(1) Process of Configuring Criteria for TRP Selection and Delivering Performance Information when it is Required to Additionally Transmit User Data in the MTRP Environment

In the present disclosure, it is assumed that in the MTRP NCJT environment, two TRPs (e.g. TRP A and TRP B) support a single terminal, and when the terminal is communicating with the TRP A, it is required to transmit additional user data to the terminal. In this case, from the terminal's perspective, there may be a method of receiving additional user data transmission by allocating more resources to communication with the TRP A, that is, a method of receiving additional user data from the TRP A, and a method of selecting the TRP B and receiving additional user data transmission from the TRP B, which is a new TRP.

FIG. 9 is a signal flow diagram according to an exemplary embodiment of an operation in which a terminal respectively obtains information on TRPs from the TRPs in an MTRP NCJT environment.

As shown in FIG. 9, since a TRP A 901 and a TRP B 902 are assumed to be in an NCJT environment, there may be a case where a link (e.g. backhaul link) for communication between the TRP A 901 and the TRP B 902 is not established. A terminal 911 may be in a state where it can establish a communication link with the TRP A 901 and receive information on the TRP A 901 from the TRP A 901. In addition, the terminal 911 may be in a state where it can establish a communication link with the TRP B 902 and receive information on the TRP B 902 from the TRP B 902. In this case, the TRP A 901 may be assumed as a serving cell, and the TRP B 902 may be assumed as a non-serving cell.

In order to solve a problem of desynchronization between TRPs in the MTRP NCJT environment, the terminal 911 may identify TRP IDs, which are identification information of all TRPs communicating with the terminal 911, and information on a frequency band allocated to each TRP. In other words, the terminal 911 may receive information on the TRP ID of the TRP A 901 and information FrequencyInfoDL on the frequency band of the TRP A 901 in step S910a, and the terminal 911 may receive information on the TRP ID of the TRP B 902 and information FrequencyInfoDL on the frequency band of the TRP B 902 in step S910b. In the example of FIG. 9, only two TRPs 901 and 902 are exemplified, but when connected to three or more TRPs, the terminal 911 may obtain information on a TRP ID and a frequency band of each of all the TRPs.

In the present disclosure, the problem of desynchronization between the TRPs 901 and 902 in the NCJT environment may be resolved through the terminal 911.

Therefore, information on the TRP IDs and frequency bands may be utilized in a process for the terminal 901 to act as an intermediate forwarder, a process of selecting an optimal TRP, and a process for the selected TRP to transmit additional user data to the terminal 911.

The operation of FIG. 9 will be described again. In step S910a, the TRP A 901, which is a serving cell, may transmit information on its own TRP ID and its own frequency band to the terminal 911. As a method by which the TRP A 901 transmits the information to the terminal 911, at least one of an SIB, DCI, RRC reconfiguration message, or new RRC signaling message may be used. The information on the TRP ID and the frequency band of the TRP may be referred to as ‘TRP information’.

In addition, the TRP B 902, which is a non-serving cell, may transmit information on its own TRP ID and its own frequency band to the terminal 911 in step S910b identically to the procedure of TRP A 901, when the TRP B 902 is RRC-connected with the terminal 911. In other words, the TRP B 902, which is a non-serving cell that is RRC-connected with the terminal 911, may transmit TRP information to the terminal 911. In this case, the TRP B 902 may transmit the TRP information to the terminal 911 using at least one of an SIB, DCI, RRC reconfiguration message, or new RRC signaling message.

If the TRP B 902, which is a non-serving cell, is in the RRC inactive state with the terminal 911, the TRP B 902 may transmit information on its own TRP ID and its own frequency band, which is TRP information, in step S910b using at least one of an SIB, DCI, Msg2 or Msg B.

The terminal 911 may deliver information on the TRP ID and frequency band (i.e. TRP information) which is received from each TRP to other TRPs.

For example, the terminal 911 may deliver TRP information of the TRP A 901 to other TRP(s), for example, TRP B 902, in step S910a using UCI, UE assistance information, or new RRC signaling message.

In addition, when the TRP B 901 (i.e. non-serving cell) is in the RRC-connected state with the terminal 911, the terminal 911 may deliver TRP information received from other TRP(s) to the TRP B 902 in step S910b, identically to the case of the TRP A 901, through UCI, UE assistance information, or new RRC signaling message.

If the terminal 911 is in the RRC inactive state with the TRP B 902, the terminal 911 may deliver TRP information received from other TRP(s) to the TRP B 902 in step S910b through Msg1 or MsgA, or using SN UE assistance information of an SRB3 or new SRB3 signaling message.

Through the process of FIG. 9 described above, all TRPs connected to the terminal 911 may identify each other's TRP ID and frequency band. Additionally or alternatively, all TRPs connected to the terminal 911 may establish a backhaul that can directly exchange information between base stations connected to all the TRPs by exchanging TRP ID information with each other through the terminal 911.

FIG. 9 described above may correspond to a procedure for exchanging information through the terminal 911 because synchronization between the TRPs is impossible in the MTRP NCJT environment. In other words, the terminal 911 may identify (or obtain) the TRP IDs, which are identification information of all TRPs communicating with it. In addition, the terminal 911 may transmit TRP information of all TRPs connected to the terminal 911, in other words, information on TRP IDs of the respective TRPs and information on frequency bands assigned to the respective TRPs, to all the TRPs, so that all the TRPs currently communicating with the terminal identify existence of other TRPs.

The information that can be obtained from the terminal 911 through the procedure of FIG. 9 may be exemplified as in Table 2 below. In addition, the terminal 911 may transmit information of Table 2 or the remaining information excluding the corresponding TRP information among the information of Table 2 to each of the TRPs communicating with the terminal 911. Through this, all TRPs communicating with the terminal 911 may obtain the information of Table 2 below.

TABLE 2

| TRP | Obtained TRP information |
|---|---|
| TRP A | TRP ID_A, FrequencyInfoDL_A |
| TRP B | TRP ID_B, FrequencyInfoDL_B |

The exemplary embodiment of FIG. 9 described above may be used in combination with at least one of other exemplary embodiments described below.

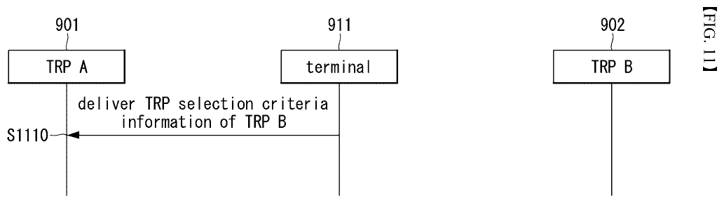

FIG. 10 is a signal flow diagram according to an exemplary embodiment of information transfer for determining TRP selection criteria in an MTRP NCJT environment.

As shown in FIG. 10, the TRP A 901, TRP B 902, and terminal 911 are exemplified in the same manner as described above in FIG. 9. Therefore, a procedure of FIG. 10 also assumes the NCJT environment. In other words, FIG. 10 may correspond to a case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

FIG. 10 assumes a situation where the TRP A 901 wishes to transmit additional user data to the terminal 911. In this case, since the terminal 911 is in the MTRP environment, a TRP to transmit additional user data needs to be selected. Therefore, selection criteria for a TRP to transmit additional user data in the MTRP environment may first be configured. The selection criteria for a TRP to transmit additional user data may consider various factors. In the present disclosure described below, a method using a reference signal received power (RSRP) of SSB as a selection criterion for a TRP to transmit additional user data will be described. In addition, in the present disclosure, a method using frequency resource utilization for a common frequency band of different TRPs will be described as a selection criterion for a TRP to transmit additional user data. In order to help understanding, in the present disclosure, the RSRP of SSB and/or the frequency resource utilization for the common frequency band will be described as a selection criterion for a TRP to transmit additional user data. However, the present disclosure is not limited thereto, and other selection criteria may be utilized. For example, factors such as a load level of the TRP, transmission power level of the TRP, mobility of the terminal, and latency level required by the terminal may be additionally or partially substituted for other criteria.

The TRP A 901 may transmit TRP selection criteria information to the terminal 911 in step S1010a. In this case, the TRP selection criteria information may be transmitted by being included in a report request signal or a report request message. For convenience of description, the following description will be made assuming that the TRP selection criteria information is transmitted by being included in a report request message. The report request message may be a message requesting the terminal 911 to report information corresponding to TRP selection criteria based on the TRP selection criteria information. The report request message may indicate specific TRPs. Such indication for TRP(s) may be made based on the information previously obtained through the terminal 911 as described in FIG. 9. For example, if the TRP A 901 receives information on three TRPs from the terminal 911 in the manner described in FIG. 9, the report request message may include three TRP IDs. In addition, the report request message may include the TRP selection criteria information. The criteria to be used as the TRP selection criteria may be arbitrarily configured by the TRP A 901 or preconfigured. The TRP selection criteria information may be indicated through an SIB or RRC reconfiguration message. In the present disclosure, as described above, the case may be assumed where the RSRP of SSB and/or the frequency resource utilization for the common frequency band is used.

First, the TRP A 901 may know in advance the existence of the TRP B 902 capable of communicating with the terminal 911 through the procedure of FIG. 9 described above. A strength of a signal received from each TRP may be used as a TRP selection criterion for additional data transmission. Accordingly, the TRP A 901 may instruct the terminal 911 to perform reporting of a measured of RSRP of an SSB received from the TRP B 902.

In addition, if the TRP A 901 performs the procedure of FIG. 9 described above, the TRP A 901 may know the common frequency band of the TRP A 901 and TRP B 902 based on the TRP information received from the terminal 911. Therefore, the TRP A 901 may configure information on a frequency resource usage ratio for the common frequency band of the TRP B 902 as a TRP selection criterion and transmit it to the terminal 911. As the information on the frequency resource usage ratio for the common frequency band of the TRP A and TRP B, a parameter frequencyResource Utilization defined in the present disclosure may be used. The parameter frequencyResourceUtilization defined in the present disclosure may be a value representing, as a ratio, a degree to which each TRP is using the corresponding frequency band based on the common frequency band of the TRPs (i.e. TRP A 901 and TRP B 902) that can communicate with the terminal 901.

As described above, information that needs to be requested from another TRP (e.g. TRP B 902) as a criterion for selecting a TRP to transmit additional user data may be resource utilization information of the TRP. The resource utilization information is described as a ratio of a degree to which each TRP is using the corresponding frequency band based on the common frequency band of the TRPs described in the present disclosure, but may include a load ratio of the TRP (i.e. a load ratio of the TRP B). As another example, the resource utilization information may include a transmission power of the TRP B 902. It will be apparent to those skilled in the art that various other pieces of information may correspond to the resource utilization information of the TRP.

The selection criteria information for additional user data transmission may be indicated to the terminal 911 using a UEInformationRequest IE of RRC signaling. Accordingly, in step S1010a, the terminal 911 may be instructed to measure and report an RSRP of an SSB received from the TRP B 902 and/or to report a frequency resource utilization of the TRP B 902 for the common frequency band of the TRP A and TRP B. As another example, the TRP A 901 may use an SIB, RRC reconfiguration or new signaling when transmitting the information instructing the terminal 911 to measure and report an SSB of the TRP B 902 and/or to report a frequency resource utilization of the TRP B 902.

Upon receiving the report request message including the TRP selection criteria information for additional user data transmission in step S1010a, the terminal 911 may identify a target TRP based on the received TRP selection criteria information. Since only two TRPs are exemplified in FIG. 10, the target TRP may be the TRP B 902. In addition, the terminal 911 may identify information that needs to be requested from the TRP B 902 based on the received TRP selection criterion information. For example, if both the measurement report of the RSRP of SSB from the TRP B 902 and the report of the frequency resource usage ratio for the common frequency band of the TRP A and TRP B are indicated in step S1010a through the TRP selection criterion information, the terminal 911 may identify that the information on the frequency resource usage ratio of the TRP B for the common frequency band of the TRP A and TRP B is the information that needs to be requested from the TRP B 902. In this case, as described above, the instruction for the report of the frequency resource usage ratio for the common frequency band of the TRP A and TRP B may use the UEInformationRequest IE.

Based on the identification in step S1010a, in step S1010b, the terminal 911 may request or inquire about frequency resource utilization information for the common frequency band of the TRP A and TRP B to the TRP B 902 to obtain the frequency resource utilization information for the common frequency band of the TRP

A and TRP B.

In step S1010b, if the terminal 911 and the TRP B 902 are RRC-connected, the terminal 911 may request or inquire about frequency resource utilization information for the common frequency band of TRP A and TRP B to the TRP B using UCI or new RRC signaling. As another example, in step S1010b, if the terminal 911 and the TRP B 902 are in the RRC inactive state, the terminal 911 may request or inquire about frequency resource utilization information for the common frequency band of TRP A and TRP B to the TRP B 902 using Msg1, Msg A, or SRB3 signaling defined for transmitting the request according to the present disclosure. The SRB3 signaling defined in the present disclosure may have a field for requesting the frequency resource utilization information for the common frequency band of TRP A and TRP B.

Based on the above-described procedure, the TRP B 902 may receive the request or inquiry message for frequency resource usage ratio information for the common frequency band of TRP A and TRP B from the terminal 911 in step S1010b. In response, the TRP B 902 may generate frequency resource usage ratio information as a response message and transmit it to the terminal 911 in step S1020. In step S1020, if the terminal 911 and the TRP B 902 are RRC-connected, a frequencyResource Utilization IE including the frequency resource usage ratio information for the common frequency band of TRP A and TRP B may be transmitted to the terminal 911 by being included in RRC signaling. In this case, the response message may be transmitted through RRC signaling.

In step S1020, if the terminal 911 and TRP B 902 are in the RRC inactive state, the frequencyResourceUtilization IE including frequency resource usage ratio information for the common frequency band of TRP A and TRP B may be transmitted to the terminal 911 through Msg2 or MsgB. In this case, the response message may be transmitted through Msg2 or MsgB.

Meanwhile, if there is no information to be requested (or inquired) and received from the TRP B 902, such as frequency resource usage ratio information for the common frequency band of TRP A and TRP B, according to the TRP selection criteria information, steps S1010b and S1020 may be omitted. For example, if the TRP selection criteria indicated in step S1010a includes only information for measuring a reception power of a reference signal included in an SSB received from the TRP B 902 and reporting an RSRP, steps S1010b and S1020 may be omitted.

In the above-described exemplary embodiment, the procedure for the terminal 901 to obtain an RSRP by measuring a reception power of a reference signal included in an SSB received from the TRP B 902 is widely known. Therefore, in FIG. 10, specific description on the procedure for the terminal 901 to obtain an RSRP for an SSB from the TRP B 902 is omitted.

FIG. 10 described above may correspond to an example in which criteria for TRP selection are configured as an SSB RSRP and a frequency resource usage ratio. The exemplary embodiment of FIG. 10 may be modified in other forms. For example, the TRP selection criteria may be configured in advance by each TRP or serving TRP to the terminal 911. When the TRP selection criteria are configured in advance to the terminal 911, the serving TRP may transmit report instruction information to the terminal when additional user data transmission is required, thereby performing steps S1010b and S1020 of FIG. 10. When the TRP selection criteria are configured in advance to the terminal 911 as described above, the TRP A 901 may instruct the terminal 911 to report SSB RSRPs and frequency resource usage ratios of other TRPs to the TRP A 901 through SIB or RRC reconfiguration when the TRP selection process needs to be performed.

According to the procedure of FIG. 10 described above, the TRP criteria and the information that the TRP B 902 transmits to the terminal 911 or that the terminal 911 obtains from the TRP B 902 may be summarized as in Table 3 below.

TABLE 3

| TRP selection criteria | Information (TRP B → terminal) |
|---|---|
| SSB RSRP | SSB |
| Frequency resource usage ratio | frequencyResourceUtilization |

Meanwhile, the exemplary embodiment of FIG. 10 described above may be used in combination with at least one of the exemplary embodiment of FIG. 9 and/or exemplary embodiments to be described below.

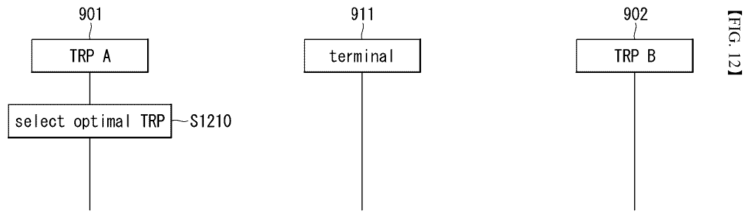

FIG. 11 is a signal flow diagram according to an exemplary embodiment in which a terminal transmits TRP selection criteria information obtained from another TRP to a serving TRP in an MTRP NCJT environment.

As shown in FIG. 11, the TRP A 901, TRP B 902, and terminal 911 are exemplified in the same manner as described above in FIG. 9. Therefore, a procedure of FIG. 11 also assumes the NCJT environment. In other words, FIG. 11 may correspond to the case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

FIG. 11 may illustrate a procedure in which the terminal 911 measures an SSB RSRP of the TRP B 902 based on the information received in FIG. 10 described above, and transmits the SSB RSRP and/or frequency resource utilization information together with a TRP ID of the TRP B 902 to the TRP A 901. In other words, the procedure of FIG. 11 may be performed after at least part of the procedure of FIG. 10 is performed. As another example, if the TRP A 901 instructs the terminal 911 to report information related to the selection criteria for the TRP B 902 at a preset periodicity, the terminal 911 may report information related to the TRP selection criteria indicated in advance by the TRP A 901 for the TRP B 902 at a specific periodicity.

In the following description, for the convenience of description, the procedure of FIG. 11 will be assumed as a subsequent procedure for the procedure of FIG. 10. That is, it is assumed that the procedure of FIG. 11 is a procedure after step S1020 of FIG. 10.

Before performing step S1110 of FIG. 11, the terminal 911 may have been instructed (or requested) by the TRP A 901 to perform reporting related to the TRP selection criteria for the TRP B 902 in advance through the UEInformationRequest of RRC signaling. As described above, the reporting instruction (or request) may include the request for SSB measurement and reporting for the TRP B 902 and/or the request for frequency resource usage ratio reporting for the TRP B 902, and the reporting instruction may be made using the UEInformationRequest message that is RRC signaling.

The terminal 911 may have obtained all the information to be reported (or responded) to the TRP A 901 through the procedure of FIG. 10. Therefore, the terminal 911 may include the information obtained through the procedure of FIG. 10 in a report (or response) message and transmit it to the TRP A 901 in step S1110. As the report message transmitted in step S1110, the UEInformationResponse message may be used. As another example, the report message transmitted in step S1110 may use UCI, measurement report, UE assistance information, and/or the like. As another example, the report message transmitted in step S1110 may use RRC signaling defined to report a TRP selection criteria response according to the present disclosure. As another example, the report message transmitted in step S1110 may use Msg1 or MsgA used in a RACH procedure.

The report message may include information (e.g. a terminal identifier as a transmitter address, a TRP A identifier as a destination address) to notify that the terminal 911 is transmitting the message to the TRP A 901. In addition, the report message may include information related to the TRP selection criteria for the TRP B 902 requested by the TRP A 901 and the identifier of the TRP B 902.

In addition, if it is assumed that two TRPs establish a backhaul link between base stations connected to the respective TRPs through identification of each other's TRP ID based on the procedure of FIG. 9, instead of the procedure of FIG. 10 and FIG. 11, the base station connected to the TRP A 901 may transmit information requesting transmission of a measured SSB RSRP and a frequency resource usage ratio of the TRP B to the base station connected to the TRP B 902 by utilizing the backhaul link between the base stations. In addition, the base station connected to the TRP B 902 may directly transmit information on the RSRP of the measured SSB and the frequency resource usage ratio to the base station connected to the TRP A 901 through the backhaul link between the base stations in response to the received request information. Through the procedure of FIG. 11 above, the TRP A 901 may obtain information on the TRP B 902, as exemplified in Table 4 below.

TABLE 4

| TRP (TRP ID) | RSRP value | frequencyResourceUtilization |
|---|---|---|
| TRP B (TRP ID_B) | RSRP_100 | 70% |

The form exemplified in Table 4 assumes the case where only one TRP exists, as described in FIGS. 9 to 11. Therefore, in the procedure of FIG. 9, if the TRP A 901 receives information on two or more TRPs from the terminal 911, the TRP A 901 may obtain information such as Table 4 for each of the corresponding TRPs, or obtain a table having fields for additional TRP(s) under the fields corresponding to the TRP B.

Meanwhile, the exemplary embodiment of FIG. 11 described above may be used in combination with at least one of the exemplary embodiments of FIG. 9 and FIG. 10 described above and/or at least one of exemplary embodiments to be described below.

Based on the operation of FIG. 9 described above, the operations of FIG. 10 and FIG. 11 may be combined to select a TRP suitable for additional user data transmission. Based on the criteria configured in advance for TRP selection, the TRP A 901, which is a serving TRP, may obtain information needed for selecting a TRP suitable for additional user data transmission from the TRP B 902. In this case, considering the MTRP NCJT environment, the terminal 911 may be configured as an intermediate forwarder. Therefore, the TRP A 901 may obtain the necessary information from the TRP B 902 through the terminal 911.

In addition, if it is assumed that a backhaul link is established between the base stations connected to the respective TRPs through the procedure of FIG. 9, in the procedures of FIG. 10 and FIG. 11, the information may be requested and transmitted directly through the backhaul link between the base stations connected to the TRP A 901 and TRP B 902, respectively, without using the terminal 911 as an intermediate forwarder.

### (2) Technique of Selecting an Optimal TRP for Additional User Data Transmission Based on Received Performance Information

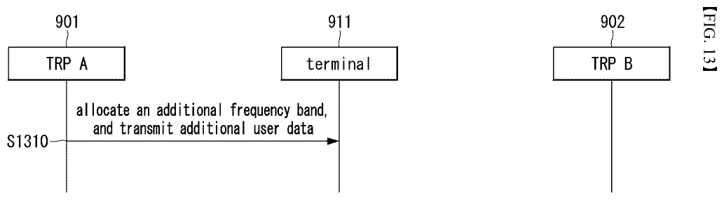

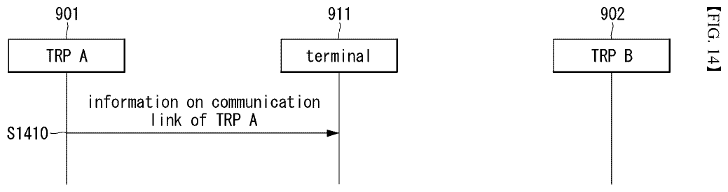

In the previous section (1), the procedure for configuring the criteria for additional user data transmission and receiving the information needed to determine a suitable TRP from the TRP B 902 through the terminal 911 has been described. Hereinafter, a procedure for selecting the optimal TRP for additional user data transmission based on the received information on the performance of the TRP B 902 will be described with reference to FIGS. 12 and 13.

If the TRP A 901 uses only SSB RSRP information for TRP selection, the TRP A 901 may compare an SSB RSRP of the TRP A 901 and an SSB RSRP of the TRP B 902 to determine which TRP can provide better communication quality to the terminal 911 in terms of reception power.

On the other hand, if the optimal TRP is determined based on how much frequency resources are used in each TRP for the common frequency band of TRP A 901 and TRP B 902, the optimal TRP may be selected by selecting a TRP with a low frequency resource usage ratio among the TRP A 901 and TRP B 902, thereby selecting a TRP that can potentially provide a high transmission rate.

Additionally or alternatively to the SSB RSRP and frequency resource usage ratio, the optimal TRP may also be selected by considering a latency requirement of the terminal 911 or a mobility of the terminal 911. If the latency requirement of the terminal is considered, a TRP that supports higher performance in terms of user experienced data rate may be selected. As another example, if the mobility of the terminal is considered, a TRP that can transmit data to the terminal 911 for a longer period of time may be selected based on the mobility or trajectory of the terminal.

FIG. 12 is a signal flow diagram according to an exemplary embodiment of the present disclosure in which a TRP A selects an optimal TRP based on SSB RSRP and/or frequency resource utilization in an MTRP NCJT environment.

As shown in FIG. 12, the TRP A 901, TRP B 902, and terminal 911 are exemplified in the same manner as described above in FIGS. 9 to 11. Therefore, a procedure of FIG. 12 also assumes the NCJT environment. In other words, FIG. 12 may correspond to the case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

In addition, it may be assumed that the TRP A 901 has received an RSRP value for an SSB transmitted by the TRP A 901 from the terminal 911 in advance. In addition, the TRP A 901 may be in a state where it has received information on the TRP B 902 through the procedure of FIG. 11 described above. Therefore, the TRP A may have information as shown in Table 5 below.

TABLE 5

| TRP (TRP ID) | RSRP value | frequencyResourceUtilization |
|---|---|---|
| TRP A (TRP ID_A) | RSRP_69 | 30% |
| TRP B (TRP ID_B) | RSRP_100 | 70% |

In Table 5, the TRP A 901 may know the RSRP value and frequencyResource Utilization value of the TRP A 901 in advance. For example, the RSRP value of the TRP A 901 in Table 5 may be an RSRP value that the terminal 911 measured an SSB transmitted by the TRP A 901 and reported to the TRP A 901. In addition, the RSRP value and frequencyResource Utilization value of the TRP B 902 may be values obtained (or received) from the terminal 911 through the procedure of FIG. 11.

Table 5 exemplifies a case where the RSRP value of the TRP B 902 is larger when comparing the RSRP of the TRP A 901 measured and reported by the terminal 911 and the RSRP of the TRP B 902 measured and transmitted by the terminal 911 to the TRP A 901. In addition, according to Table 5, a case is exemplified where the frequency resource usage ratio of the TRP A 901 is lower than that of the TRP B 902.

In step S1210, if the TRP A 901 determines only with the SSB RSRPs, the TRP B 902 with a larger SSB RSRP may be selected as the optimal TRP. As another example, in step S1210, if the TRP A 901 determines only with the frequency resource usage ratios, the TRP A 901 with a lower frequency resource usage ratio may be selected.

Meanwhile, FIG. 12 illustrates an example of the case where the TRP A 901 determines only with SSB RSRPs or frequency resource usage ratios when selecting a suitable TRP for additional user data transmission, but the exemplary embodiment may be expanded to a method of selecting a TRP by using other determination criteria such as a latency requirement of the terminal 911 or mobility of the terminal 911 in addition to the SSB RSRPs and frequency resource usage ratios, or a method of selecting a TRP by comprehensively considering multiple criteria.

FIG. 12 illustrates an example of selecting the optimal TRP based on only one criterion among SSB RSRP and frequency resource usage ratio, but the exemplary embodiment may also be expanded to select a TRP by considering both in combination.

Meanwhile, the exemplary embodiment of FIG. 12 described above may be used in combination with at least one of the exemplary embodiments of FIG. 9 to FIG. 11 described above and/or at least one of exemplary embodiments to be described below.

Hereinafter, a case where the TRP A 901 is selected as the optimal TRP and a case where the TRP B 902 is selected as the optimal TRP will be described respectively. The cases where the TRP A 901 or TRP B 902 is selected for additional user data transmission may be exemplified as shown in Table 6 below.

TABLE 6

| TRP ID | TRP ID information |
|---|---|
| TRP ID_A | TRP A is selected for additional user data transmission |
| TRP ID_B | TRP B is selected for additional user data transmission |

In step S1210, the TRP A 901 may select the TRP A 901 or TRP B 902 as a TRP to be responsible for additional user data transmission by comparing its own SSB RSRP and frequency resource usage ratio with the SSB RSRP and frequency resource usage ratio of the TRP B 902 received from the terminal 911.

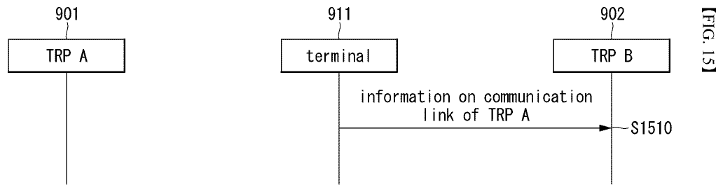

The TRP A 901 may select a TRP based on the information described above, and may transmit a TRP ID of the selected TRP to the terminal 911. The transmission of the TRP ID of the selected TRP may be performed in procedures of FIG. 13 and/or FIG. 14 described below.

For example, if the TRP A 901 is selected, the TRP A 901 may transmit information indicating additional user data transmission to the terminal 911 by including a TRP ID_A in it. As another example, if the TRP B 902 is selected, the TRP A 901 may transmit information indicating additional user data transmission to the terminal 911 by including a TRP ID_B in it. As described above, transmission of the TRP ID of the selected TRP, which is the information indicating additional user data transmission, may be performed in a procedure of FIG. 13 and/or FIG. 14 described below.

Therefore, the terminal 911 may determine from which TRP additional user data will be received and how a resource allocation process will proceed in the future based on the TRP ID included in the information indicating additional user data transmission. For example, if the TRP ID included in the information indicating additional user data transmission is the TRP ID_A, the terminal 911 may know that it will receive additional user data from the TRP A 901 in the future. Conversely, if the TRP ID included in the information indicating additional user data transmission is the TRP ID_B, the terminal 911 may know that it will receives additional user data from the TRP B 902. Therefore, the terminal 911 may determine that the terminal will receive, from the TRP A 901, information needed to receive user data from both the TRP A 901 and TRP B 902, that is, information on an SCS, cyclic prefix length, FFT size, etc. for a first resource that TRP A 901 uses (or is using or has used) for communication with the terminal 911. This will be described in more detail in FIG. 14 described below.

The information indicating additional user data transmission, which includes the TRP ID, may be transmitted to the terminal 911 through DCI, RRC reconfiguration, or RRC signaling newly defined to transmit the information according to the present disclosure.

Meanwhile, the exemplary embodiment of FIG. 12 described above may be used in combination with at least one of the exemplary embodiments of FIG. 9 to FIG. 11 described above and/or at least one of exemplary embodiments to be described below.

### (3) Additional Resource Allocation Technique for Selected TRP

Hereinafter, the present disclosure will describe an additional resource allocation technique for the selected TRP.

The additional resource allocation technique for the selected TRP may include a series of processes required until the terminal 911 receives additional user data after the TRP to perform additional user data transmission is determined.

FIG. 13 is a signal flow diagram according to an exemplary embodiment for a case where a TRP A is selected for additional user data transmission in an MTRP NCJT environment.

As shown in FIG. 13, the TRP A 901, TRP B 902, and terminal 911 are exemplified in the same manner as described above in FIGS. 9 to 12. Therefore, a procedure of FIG. 13 also assumes the NCJT environment. In other words, FIG. 13 may correspond to the case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

Meanwhile, FIG. 13 may illustrate a case where the TRP A 901 is selected among the TRP A 901 and the TRP B 902 as a TRP for additional user data transmission. The TRP A 901 may have been selected as the optimal TRP according to the previously described procedure in FIG. 12 and information on the optimal TRP may have been transmitted to the terminal 911. Therefore, the terminal 911 may know in advance that the TRP A 901 is a TRP for additional data transmission based on the information indicating additional user data described in FIG. 12.

Since the TRP A 901 is a serving cell for the terminal 911, a communication link that is being used for communicating with the terminal 911 may exist. Therefore, in step S1310, the TRP A 901 may allocate resources, for example, an additional frequency band, to the terminal 911 and transmit additional user data to the terminal 911 through the additionally allocated frequency band. In this case, the additional user data may be transmitted through an additionally allocated PDSCH.

The situation of FIG. 13 may correspond to a situation in which the additional frequency band and/or time resources are allocated to communication between the TRP A 911 and the terminal 901 for additional user data transmission to the terminal 911 without intervention of another TRP other than the TRP A 901 previously communicating with the terminal 911. In this case, the additional frequency band may be allocated within a bandwidth part (BWP) allocated to the terminal 911 in advance. If a frequency band of the BWP is insufficient, BWP switching may be instructed to allocate the additional band to the terminal 911. Then, in step S1310, the TRP A 901 may transmit additional user data to the terminal 911 by using the additionally allocated resources, for example, the frequency band and/or time resources.

In information transmitted by the TRP A 901 to the terminal 911 in step S1310, information on the TRP ID and allocation of the additional frequency band may be transmitted to the terminal 911 through DCI, RRC reconfiguration, or RRC signaling newly defined to transmit the information according to the present disclosure.

In step S1310, information exemplified in Table 7 below may be delivered from the TRP A 901 to the terminal 911. As described in FIG. 12, the TRP ID of the TRP A 901 may be transmitted by being included as a TRP ID in the information indicating additional user data transmission. Then, allocation information the additional frequency band for transmitting additional user data may be transmitted. Finally, additional user data may be transmitted through the additional frequency band based on the allocation information of the additional frequency band.

TABLE 7

| | Delivered information |
|---|---|
| TRP A → terminal | TRP ID = TRP ID_A |
| | Additional frequency band allocated for additional |
| | user data transmission |
| | Additional user data |

Meanwhile, the exemplary embodiment of FIG. 13 described above may be used in combination with at least one of the exemplary embodiments of FIG. 9 to FIG. 12 described above and/or at least one of exemplary embodiments to be described below.

FIG. 14 is a signal flow diagram according to an exemplary embodiment for a case where a TRP B is selected for additional user data in transmission an MTRP NCJT environment.

As shown in FIG. 14, the TRP A 901, TRP B 902, and terminal 911 are exemplified in the same manner as described above in FIGS. 9 to 13. Therefore, a procedure of FIG. 14 also assumes the NCJT environment. In other words, FIG. 14 may correspond to the case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

FIG. 14 illustrates a case where the TRP B 902 is determined to be suitable for additional user data transmission through the process of FIG. 12 described above. Therefore, the terminal 911 may have received information indicating ‘TRP ID=TRP ID_B’ from the TRP A 901 through the information indicating additional user data transmission.

In step S1410, the TRP A 901 may transmit on an SCS, CP length, FFT size, etc. that were used in the communication link between the TRP A 901 and terminal 911 to the terminal 911. In the present disclosure, the information on the SCS, CP length, FFT size, etc. may be information related to the size of data to be transmitted, for example, information related to a resource block (RB) and/or physical resource block (PRB).

In other words, step S1410 of FIG. 14 may be an operation after the TRP B 902 is selected as the TRP to perform additional user data transmission, as described in FIG. 12. In this case, the terminal 911 may already be receiving user data from the TRP A 901, which is a serving cell. Therefore, the TRP A 901 may provide information on the existing communication link, for example, information related to RB and/or PRB, in order for the terminal 911 to be able to receive signals from the TRP A 902 and the TRP B 902 at the same time.

Since the terminal 911 can activate only one BWP at the same time, in order to communicate with two TRPs at the same time, the sizes of RB and/or PRB (e.g. SCSs, CP lengths, and FFT sizes) of signals received from the TRPs may need to match. However, the current standards cannot guarantee that TRP B 902 knows the information related to the communication link that the existing TRP A 901 is using in the MTRP NCJT situation. In other words, it may not be guaranteed that the TRP B 902 knows the information related to the communication link between the TRP A 901 and the terminal 911, that is, the information related to the RB size and/or PRB size. In case that the TRP B 902 does not know the information on the existing communication link, when the TRP A 901 cannot allocate resources to the terminal 911 or when the TRP B 902 can allocate better resources than the TRP A 901, the SCSs, cyclic prefixes, FFT sizes, etc. of the two TRPs may not match. In this case, there may be a situation in which the TRP B 902 cannot allocate resources to the terminal 911.

Therefore, the procedure of FIG. 14 may be regarded as a part of a process of delivering information related to the existing communication link between the TRP A 901 and the terminal 911 to the TRP B 902 through the terminal 911 to solve the above-described problem situation when the TRP B 902 is selected for additional user data transmission. The TRP ID, which is information transmitted by the TRP A 901 to the terminal 911 in the procedure of FIG. 14, and the information such as SCS, CP length, and FFT size, which is information related to the communication link between the existing TRP A 901 and the terminal 911, may be transmitted to the terminal 911 through DCI, RRC reconfiguration, or RRC signaling newly defined to transmit information according to the present disclosure.

In addition, combinations of the information (i.e. SCS, CP, FFT size, etc.) related to the communication link between the TRP A 901 (i.e. serving cell) and the terminal 911 may be predefined so that they are be expressed as preconfigured indexes. When the indexes are predefined, the TRP A 901 that is a serving cell may transmit a corresponding index value indicating information related to communication link to the terminal 911.

According to FIG. 14 described above, the information transmitted from the TRP A 901 to the terminal 911 may be exemplified as Table 8 below.

TABLE 8

| | Delivered information |
|---|---|
| TRP A → terminal | TRP ID = TRP ID_B |
| | SCS, cyclic prefix, FFT size |

Meanwhile, the exemplary embodiment of FIG. 14 described above may be used in combination with at least one of the exemplary embodiments of FIG. 9 to FIG. 13 described above and/or at least one of exemplary embodiments to be described below.

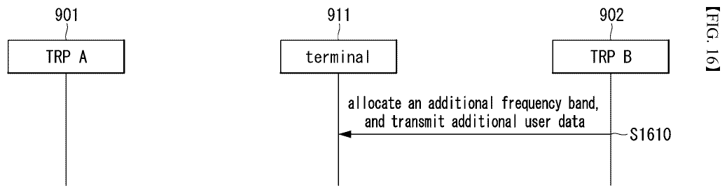

FIG. 15 is a signal flow diagram according to an exemplary embodiment for a case where a TRB B, which is a non-serving cell, is determined as a TRP transmitting additional user data in an MTRP NCJT environment.

As shown in FIG. 15, the TRP A 901, TRP B 902, and terminal 911 are exemplified in the same manner as described above in FIGS. 9 to 14. Therefore, a procedure of FIG. 15 also assumes the NCJT environment. In other words, FIG. 15 may correspond to the case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

The operation illustrated in 15 may correspond to an operation when ‘TRP ID=TRP ID_B’ is indicated by the TRP A 901 through the information indicating additional user data transmission as described in FIG. 14 above. In this case, the terminal 911 may confirm that it needs to receive additional user data from the TRP B 902.

Based on the above confirmation, in step S1510, the terminal 911 may transmit, to the TRP B 902, the TRP ID of the TRP B 902 and the information related to the communication link of the TRP A 901, which are information needed for the terminal 911 to simultaneously receive data from the TRP A 901 and TRP B 902.

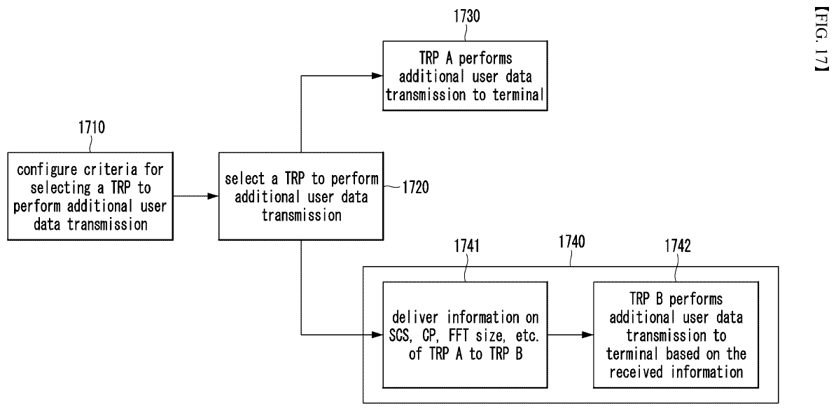

In addition, in an operation of FIG. 16 described later, the TRP B 902 may confirm that the TRB B 902 is an entity responsible for additional user data transmission based on receipt of the TRP ID of the TRP B 902. This will be described in more detail in FIG. 16 described later.

In step S1510, the communication link-related information transmitted by the terminal 911 to the TRP B 902 may include information such as SCS, CP length, and FFT size. In addition, when the terminal 911 and TRP B 902 are RRC-connected, the communication link-related information including the TRP ID indicating the TRP B 902 may be transmitted to the TRP B 902 through UCI, UE assistance information, or RRC signaling newly defined according to the present disclosure.

As another example, when the terminal 911 and TRP B 902 are in the RRC inactive state, the communication link-related information including the TRP ID indicating the TRP B 902 may be transmitted to the TRP B 902 through Msg1 or MsgA.

As another example, when the terminal 911 and TRP B 902 are in the RRC inactive state, the communication link-related information including the TRP ID indicating the TRP B 902 may be transmitted to the TRP B 902 through SN UE assistance information of SRB3 or SRB3 signaling newly defined according to the present disclosure.

As another example, when combinations of information such as SCS, CP length, FFT size, etc. used in the communication link between the existing TRP A 901 and terminal 911 are predefined as indexes, an index value defined based on the SCS, CP length, FFT size, etc. may be used to transmit the communication link-related information.

As described above in FIG. 9, if it is assumed that a backhaul link is established between base stations connected to the two TRPs by identifying each other's TRP IDs, instead of the procedures of FIGS. 14 and 15, the base station connected to the TRP A 901 may directly transmit information on the TRP ID and SCS, cyclic prefix, FFT size, etc. to the base station connected to the TRP B 902 through the backhaul link between the base stations.

Based on the above description, the information transmitted by the terminal 911 to the TRP B 902 may be summarized as in Table 9 below.

TABLE 9

| | Delivered information |
|---|---|
| Terminal → TRP B | TRP ID = TRP ID_B |
| | SCS, cyclic prefix, FFT size |

Meanwhile, the exemplary embodiment of FIG. 15 described above may be used in combination with at least one of the exemplary embodiments of FIGS. 9 to 14 described above and/or at least one of exemplary embodiments to be described below.

FIG. 16 is a signal flow diagram according to an exemplary embodiment for a case where a TRB B, which is a non-serving cell, transmits additional user data in an MTRP NCJT environment.

As shown in FIG. 16, the TRP A 901, TRP B 902, and terminal 911 are exemplified in the same manner as described above in FIGS. 9 to 15. Therefore, a procedure of FIG. 16 also assumes the NCJT environment. In other words, FIG. 16 may correspond to the case that a link (e.g. backhaul link) for communication between the TRP A 901 and TRP B 902 is not established. The terminal 911 may be in a state where it can establish a communication link with the TRP A 901 and a communication link with the TRP B 902. The TRP A 901 may be assumed as a serving cell, and the TRP B 902 may be assumed as a non-serving cell.

FIG. 16 illustrates a case where the information indicating additional user data transmission is received from the terminal 911 as described in FIG. 15. Therefore, the TRP B 902 may confirm that itself is a TRP that needs to transmit additional user data to the terminal 911 based on the TRP ID included in the information indicating additional user data transmission. In addition, the TRP B 902 may obtain the communication link-related information related to a BWP, RB or PRB to be used based on the information indicating additional user data transmission.

As described above, since the terminal 911 can activate only one BWP at the same time, in order to receive signals from the TRP A 901 and TRP B 902 at the same time, SCSs, CP lengths, and FFT sizes of signals received from the TRPs may need to match. In order to satisfy this condition, the TRP B 902 may receive information needed for synchronization with the TRP A 901 from the terminal 911. Then, the TRP B 902 may allocate time and frequency resources required for transmitting additional user data so that the SCSs, CP lengths, FFT sizes, etc. used by the TRP A 901 and TRP B 902 match based on the information needed for synchronization received from terminal 911. In other words, the TRP B 902 may allocate an additional frequency band for transmitting additional user data based on the information indicating additional user data transmission received in FIG. 15 as described above. In this case, the additional frequency band may be a band within a BWP allocated by the TRP A 901 to the terminal 911 as described above. In step S1610, the TRP B 902 may transmit additional user data using the additional frequency band allocated to the terminal 911.

Here, when the TRP B 902 and terminal 911 are RRC-connected, information on the allocated frequency band for additional user data transmission may be transmitted through SIB, DCI, RRC reconfiguration, or RRC signaling newly defined to transmit allocation information of the additional frequency band according to the present disclosure.

As another example, when the TRP B 902 and terminal 911 are in the RRC inactive state, information on the allocated frequency band for additional user data transmission may be transmitted through SIB, DCI, Msg2, or MsgB. In addition, additional user data transmitted to the terminal 911 may be transmitted through a PDSCH of the TRP B 902.

Based on FIG. 16 described above, the information and data transmitted by the TRP B 902 to the terminal 911 may be summarized as in Table 10 below.

TABLE 10

| | Delivered information |
|---|---|
| TRP B → terminal | Additional frequency band allocated for |
| | additional user data transmission |
| | Additional user data |

Meanwhile, the exemplary embodiment of FIG. 16 described above may be used in combination with at least one of the exemplary embodiments of FIG. 9 to FIG. 15 described above.

Hereinafter, the procedures of FIG. 13 to FIG. 16 above will be described comprehensively.

The procedure of FIG. 13 may be performed when the TRP A 901 is determined to be suitable for additional user data transmission. Therefore, the TRP

A 901 may inform the TRP ID_A to the terminal 911 as a TRP ID, and transmit information on additional resources together. The procedure of FIG. 14 may be performed when the TRP B 902 is determined to be better for additional user data transmission. Therefore, the TRP A 901 may inform the TRP ID_B to the terminal 911 as a TRP ID, and additionally transmit communication link related information needed for communication with the terminal 911, such as information on the RB or PRB (e.g. SCS, CP length, FFT size, etc.) currently utilized by the TRP A 901, to the terminal 911.

Therefore, the procedure of FIG. 14 may be a procedure for resolving a desynchronization problem between TRPs, which occurs when a new TRP other than the TRP A 901, which is a serving cell of the terminal 911, is selected for additional user data transmission in the MTRP NCJT environment.

The procedures of FIGS. 14 and 15 may be a procedure of transmitting communication link-related information including RB or PRB related information received from the TRP A 901, which is a serving cell of the terminal 911, to the TRP B 902, when a new TRP other than the TRP A 901 is selected for additional user data transmission in the MTRP NCJT environment. The procedure of FIG. 16 may be an operation of allocating resources for the TRP B 902 to transmit additional user data to the terminal 911 based on the communication link-related information received in FIG. 15, and transmitting the additional user data through the allocated resources.

In addition, if it is assumed that a backhaul is established between the base stations connected to the TRPs through the procedure of FIG. 9, in the procedures of FIGS. 14 and 15, requesting and delivery of the information may be directly performed by utilizing the backhaul link between the base stations respectively connected to the TRP A 901 and TRP B 902 without utilizing the terminal 911 as an intermediate forwarder.

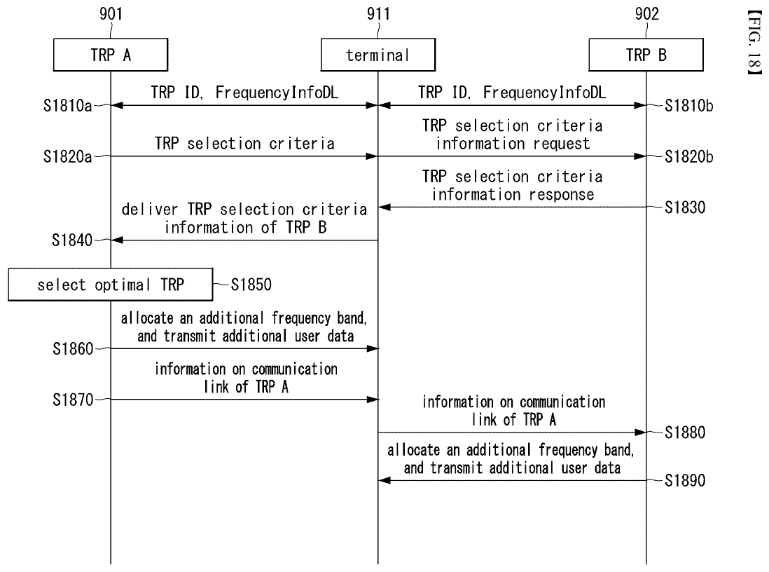

FIG. 17 is a block diagram illustrating an overall procedure for transmitting additional user data in an MTRP NCJT environment.

FIG. 17 assumes a case where the TRP 901 which is a serving cell of the terminal 911 and one or more other TRPs exist.

The TRP A 901 that is a serving cell may obtain information on at least one TRP that the terminal 911 can communicate with through the terminal 911. For example, it may be assumed that the TRP B and a TRP C can communicate with the terminal 911. Then, the TRP A 901 that is a serving cell may obtain a TRP ID of each of the TRP B and TRP C through the terminal 911. In addition, the TRP A 901 may obtain information on a frequency band information that each of the TRP B and TRP C has allocated to the terminal 911 through the terminal 911. This procedure may correspond to a case where the TRP C is added in the procedure of FIG. 9.

In step 1710, the TRP A 901 that is a serving cell may configure criteria for selecting a TRP for transmitting additional user data. Accordingly, the TRP A 901 may transmit a report request message including TRP selection criteria information for each of the TRP B and TRP C to the terminal 911. According to the TRP selection criteria information, for example, an RSRP measurement value of an SSB transmitted by the TRP B and usage ratio information of a common frequency band between the TRB B and TRP A 901 may be requested from the terminal 911 for the TRP B, and an RSRP measurement value of an SSB transmitted by TRP C and usage ratio information of a common frequency band between the TRB C and TRP A 901 may be requested from the terminal 911 for the TRP C.

In step 1710, the TRP A 901 that is a serving cell may receive a response message including the requested information corresponding to the TRP B and TRP C from the terminal 911.

Then, in step 1720, the TRP A 901 that is a serving cell may select a TRP to perform additional user data transmission based on the response message received in step 1710. Then, the TRP A 901 that has selected the TRP to perform additional user data transmission may transmit information indicating additional user data transmission to the terminal 911.

If the TRP A 901 that is a serving cell is selected as the TRP to perform additional user data transmission, step 1730 may be performed. In step 1730, the TRP A 901 may allocate additional resources to the terminal 911 and transmit additional user data to the terminal 911 using the additional resources.

On the other hand, a non-serving cell TRP may be selected as the TRP to transmit additional user data (step 1740). For example, one of the TRP B or TRP C may be selected as the TRP to transmit additional user data to the terminal 911. In FIG. 17, the TRP B may be selected as the TRP to transmit additional user data to the terminal 911.

If the TRP B that is a non-serving cell is selected as the TRP to transmit additional user data, the serving cell TRP A 901 may transmit information related to the communication link between the TRP A 901 and terminal 911 to the TRP B through the terminal 911 (step 1741). The information related to the communication link may be information for determining an RB or PRB within a BWP as described above. As examples of information for determining an RB or PRB within the BWP, the present disclosure has exemplified SCS, CP, FFT size, etc.

In step 1741, when the TRP B receives information related to the communication link between the TRP A 901 and terminal 911 from the TRP A 901, which is a serving cell for the terminal 911, through the terminal 911, the TRP B may allocate resources for transmitting additional user data to the terminal 911 based on the information related to the communication link. In this case, resources within the BWP allocated by the TRP A 901, which is a serving cell, may be allocated to the terminal 911. In addition, the resources allocated by the TRP B may include time resources and/or a frequency band. In addition, the TRP B may transmit additional user data using the resources allocated to the terminal 911.

FIG. 18 is an overall signal flow diagram for additional user data transmission in an MTRP NCJT environment.

As shown in FIG. 18, the TRP A 901, TRP B 902, and terminal 911 are illustrated. The example of FIG. 18 shows that the procedures of FIGS. 9 to 16 described above are performed sequentially. The respective steps of FIG. 18 will be briefly described in correspondence with the procedures of FIGS. 9 to 16 described above.

Steps S1810a and S1810b may correspond to steps S910a and 910b described in FIG. 9. In addition, steps S1820a, S1820b, and S1830 may correspond to steps S1010a, S1010b, and S1020 described in FIG. 10. Step S1840 may correspond to step S1110 described in FIG. 11, and step S1850 may correspond to step S1210 described in FIG. 12. Step S1860 may correspond to step S1210 described in FIG. 12, and step S1860 may correspond to step S1310 described in FIG. 13.

Meanwhile, step S1870 may correspond to step S1410 described in FIG. 14, step S1880 may correspond to step S1510 described in FIG. 15, and step S1890 may correspond to step S1610 described in FIG. 16.

FIG. 18 shows an exemplary embodiment in which all of the steps described above are connected, and an exemplary embodiment may be implemented with only some steps of the exemplary embodiments of FIG. 9 to FIG. 16. For example, an exemplary embodiment may be implemented with only steps 1710, 1720, and 1730 described in FIG. 17. As another example, an exemplary embodiment may be implemented with only steps 1710, 1720, and 1740 described in FIG. 17.

It should be noted that there may be various variations of the implementation forms, and that the present disclosure does not place any special restrictions on variations using combinations of the exemplary embodiments described above.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner. The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

1. A method of a terminal, comprising:
receiving, from a first transmission and reception point (TRP) communicating with the terminal through a first resource, a report request message including TRP selection criteria information;
determining whether the received TRP selection criteria information includes first information to be requested from a second TRP indicated by the received TRP selection criteria information;
in response to determining that the first information to be requested from the second TRP is included in the received TRP selection criteria information, transmitting a first request message requesting the first information to the second TRP; and
upon receiving a first response message including the first information from the second TRP, transmitting a second response message including the first information to the first TRP.

2. The method according to claim 1, further comprising:
obtaining information on the first TRP from the first TRP and information on the second TRP from the second TRP, before receiving the report request message;
transmitting the information on the first TRP to the second TRP; and
transmitting the information on the second TRP to the first TRP,
wherein the information on the first TRP and the information on the second TRP each include a TRP identifier (ID) and allocated frequency band information.

3. The method according to claim 2, wherein the first information is information on a utilization of a specific resource of the second TRP.

4. The method according to claim 1, further comprising: in response to the TRP selection criteria information including a request for a reference signal received power (RSRP) of a synchronization signal block (SSB) transmitted by the second TRP, measuring an RSRP of an SSB of the second TRP,
wherein the first response message further includes the RSRP of the SSB of the second TRP.

5. The method according to claim 1, further comprising:
receiving, from the first TRP, user data transmission indication information including a TRP ID;
in response to the TRP ID indicating the first TRP, receiving, from the first TRP, allocation information of a second resource different from the first resource; and
receiving user data based on the allocation information of the second resource.

6. The method according to claim 1, further comprising:
receiving, from the first TRP, user data transmission indication information including an ID of the second TRP and information related to a communication link of the first resource;
transmitting, to the second TRP, the ID of the second TRP and the information related to the communication link of the first resource;
receiving, from the second TRP, allocation information of a second resource based on the information related to the communication link of the first resource; and
receiving user data based on the allocation information of the second resource.

7. The method according to claim 6, wherein the allocation information of the second resource indicates a resource included in a same bandwidth part (BWP) as the first resource.

8. The method according to claim 6, wherein the information related to the communication link of the first resource includes information related to a physical resource block (PRB) between the first TRP and the terminal.

9. A terminal comprising at least one processor, wherein the at least one processor causes the terminal to perform:
receiving, from a first transmission and reception point (TRP) communicating with the terminal through a first resource, a report request message including TRP selection criteria information;
determining whether the received TRP selection criteria information includes first information to be requested from a second TRP indicated by the received TRP selection criteria information;
in response to determining that the first information to be requested from the second TRP is included in the received TRP selection criteria information, transmitting a first request message requesting the first information to the second TRP; and
upon receiving a first response message including the first information from the second TRP, transmitting a second response message including the first information to the first TRP.

10. The terminal according to claim 9, wherein the at least one processor further causes the terminal to perform:
obtaining information on the first TRP from the first TRP and information on the second TRP from the second TRP, before receiving the report request message;
transmitting the information on the first TRP to the second TRP; and
transmitting the information on the second TRP to the first TRP,
wherein the information on the first TRP and the information on the second TRP each include a TRP identifier (ID) and allocated frequency band information.

11. The terminal according to claim 10, wherein the first information is information on a utilization of a specific resource of the second TRP.

12. The terminal according to claim 9, wherein the at least one processor further causes the terminal to perform: in response to the TRP selection criteria information including a request for a reference signal received power (RSRP) of a synchronization signal block (SSB) transmitted by the second TRP, measuring an RSRP for an SSB of the second TRP,
wherein the first response message further includes the RSRP for the SSB of the second TRP.

13. The terminal according to claim 9, wherein the at least one processor further causes the terminal to perform:
receiving, from the first TRP, user data transmission indication information including a TRP ID;
in response to the TRP ID indicating the first TRP, receiving, from the first TRP, allocation information of a second resource different from the first resource; and
receiving user data based on the allocation information of the second resource.

14. The terminal according to claim 9, wherein the at least one processor further causes the terminal to perform:
receiving, from the first TRP, user data transmission indication information including an ID of the second TRP and information related to a communication link of the first resource;
transmitting, to the second TRP, the ID of the second TRP and the information related to the communication link of the first resource;
receiving, from the second TRP, allocation information of a second resource based on the information related to the communication link of the first resource; and
receiving user data based on the allocation information of the second resource.

15. The terminal according to claim 14, wherein the allocation information of the second resource indicates a resource included in a same bandwidth part (BWP) as the first resource.

16. The terminal according to claim 14, wherein the information related to the communication link of the first resource includes information related to a physical resource block (PRB) between the first TRP and the terminal.

17. A method of a first transmission and reception point (TRP), comprising:
in response to requiring additional user data transmission to a first terminal communicating with the first TRP using a first resource, transmitting, to the first terminal, a report request message including TRP selection criteria information obtained from a second TRP;
receiving, from the first terminal, a response message including first information related to the TRP selection criteria information, which is obtained from the second TRP;
selecting a TRP for transmitting user data to the first terminal based on the response message; and
transmitting user data transmission indication information including an identifier of the selected TRP to the first terminal.

18. The method according to claim 17, further comprising:
obtaining information on the first TRP from the first TRP and information on the second TRP from the second TRP, before transmitting the report request message;
transmitting the information on the first TRP to the second TRP; and
transmitting the information on the second TRP to the first TRP,
wherein the information on the first TRP and the information on the second TRP each include a TRP identifier (ID) and allocated frequency band information.

19. The method according to claim 17, further comprising:
in response to the selected TRP being the first TRP, allocating a second resource for transmitting additional user data to the first terminal; and
transmitting the additional user data to the first terminal through the second resource.

20. The method according to claim 17, further comprising:
in response to receiving, from a second terminal, information requesting a specific resource of the second TRP which is related to the TRP selection criteria information, generating information on a utilization of the specific resource; and
transmitting, to the second terminal, the generated information on the utilization of the specific resource.
